(19) United States
(12) Patent Application Publication
(10) Pub. No.: US 2026/0150133 A1
(43) Pub. Date: May 28, 2026

(54) PRACH RESOURCE PARTITION FOR GNSS AND GNSS-LESS OPERATIONS IN NTN

(71) Applicant: QUALCOMM Incorporated, San Diego, CA (US)

(72) Inventors: Chiranjib SAHA, Lakeside, CA (US); Ayan SENGUPTA, San Diego, CA (US); Alberto RICO ALVARINO, San Diego, CA (US)

(21) Appl. No.: 18/963,396

(22) Filed: Nov. 27, 2024

(51) Int. Cl. H04W 74/0833; H04W 72/02; H04W 72/51; H04W 74/08

(52) U.S. Cl. CPC H04W 74/0833; H04W 72/02; H04W 72/51; H04W 74/0891

(57) ABSTRACT

A method for wireless communication at a user equipment (UE) and related apparatus are provided. In the method, the UE receives a physical random access channel (PRACH) configuration from a network entity. The PRACH configuration may indicate a set of PRACH resources for the UE. The UE then selects a PRACH resource from a first PRACH resource and a second PRACH resource in the set of PRACH resources indicated by the PRACH configuration based on the presence or the absence of location information at the UE and transmits a random access message using the PRACH resource.

### TECHNICAL FIELD

The present disclosure relates generally to communication systems and, more particularly, to the partitioning of physical random access channel (PRACH) resources in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to receive, from a network entity, a physical random access channel (PRACH) configuration indicating a set of PRACH resources for the UE; select, based on a presence or an absence of location information at the UE, a first PRACH resource or a second PRACH resource in the set of PRACH resources indicated by the PRACH configuration; and transmit a random access message using the PRACH resource.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to transmit, to a user equipment (UE), a PRACH configuration indicating a set of PRACH resources, where the set of PRACH resources includes a first PRACH resource for UEs having location information and a second PRACH resource for UEs without the location information; and receive a random access message from the UE using one of the first PRACH resource or the second PRACH resource.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A and FIG. 4B illustrate example aspects of random access procedures.

FIG. 5A, FIG. 5B, and FIG. 5C are diagrams illustrating example network architectures capable of supporting non-terrestrial network (NTN) access.

FIG. 6 shows diagrams illustrating example physical random access channel (PRACH) configurations.

FIG. 7 is a diagram illustrating example PRACH preamble structures.

FIG. 8 is a diagram illustrating example PRACH occasions in the frequency domain.

FIG. 9A is a diagram illustrating an example of the utilization of different ROs in the frequency domain in accordance with various aspects of the present disclosure.

FIG. 9B is a diagram illustrating an example of the minimum time period between a physical downlink control channel (PDCCH) order and a PRACH transmission in accordance with various aspects of the present disclosure.

FIG. 10 is a diagram illustrating an example of PRACH partitioning for different types of UEs in accordance with various aspects of the present disclosure.

FIG. 11 is a call flow diagram illustrating a method of wireless communication in accordance with various aspects of the present disclosure.

FIG. 12 is a flowchart illustrating methods of wireless communication at a UE in accordance with various aspects of the present disclosure.

FIG. 13 is a flowchart illustrating methods of wireless communication at a UE in accordance with various aspects of the present disclosure.

FIG. 14 is a flowchart illustrating methods of wireless communication at a network entity in accordance with various aspects of the present disclosure.

FIG. 15 is a flowchart illustrating methods of wireless communication at a network entity in accordance with various aspects of the present disclosure.

FIG. 16 is a diagram illustrating an example of a hardware implementation for an example apparatus and/or UE.

FIG. 17 is a diagram illustrating an example of a hardware implementation for an example network entity.

### DETAILED DESCRIPTION

In wireless communication, a non-terrestrial network (NTN) refers to a network that uses non-terrestrial components, such as satellites, to provide connectivity. The NTN may extend wireless coverage to areas that are hard to reach with traditional, terrestrial-based networks, such as remote or rural regions. NTNs currently operate with the expectation that user equipment (UE) connected to the network possess location information from sources such as the Global Navigation Satellite System (GNSS). This expectation, however, makes it difficult for UEs that lack such location information to connect to the NTN. Example aspects presented herein provide methods and apparatus that enhance random access to enable the NTN to differentiate between UEs with and without location information, helping to ensure that those UEs without location information can still effectively connect to the NTN.

Various aspects relate generally to wireless communication. Some aspects more specifically relate to the partitioning of physical random access channel (PRACH) resources in wireless communication. In some aspects, PRACH resources may be referred to as random access resources. In some examples, a UE may receive a PRACH configuration indicating a set of PRACH resources for the UE from a network entity. The UE may select a PRACH resource from a first PRACH resource and a second PRACH resource in the set of PRACH resources indicated by the PRACH configuration based on the presence or the absence of location information at the UE. Then, the UE may transmit a random access message using the PRACH resource. In some examples, the first PRACH resource may be selected based on a first PRACH root and a first set of cyclic shifts in a PRACH occasion (PO), also known as a random access channel occasion (RO) in some aspects, and the second PRACH resource may be selected based on a second PRACH root and a second set of cyclic shifts in the RO. In some examples, the partitioning of PRACH resources may be performed on the time domain. For example, the first PRACH resource may include a first set of ROs, and the second PRACH resource may include a second set of ROs that does not overlap with the second set of ROs in the time domain. In some examples, the partitioning of PRACH resources (also referred to as “PRACH partition” in some aspects) may be performed on the frequency domain. For example, the first PRACH resource may include a first set of ROs, and the second PRACH resource may include a second set of ROs that does not overlap with the second set of ROs in the frequency domain. In some examples, UEs with and without location information may use different mapping rules to map the synchronization signal blocks (SSBs) to the ROs. For example, UEs with the location information may map the SSBs to ROs based on an ascending order of the ROs, and UEs without the location information may map the SSBs to the ROs based on a descending order of the ROs.

Particular aspects of the subject matter described in this disclosure can be implemented to realize one or more of the following potential advantages. In some examples, by enabling adaptive PRACH resource management in NTN for UEs with and without location information, such as that provided by the GNSS, the described techniques may be used to maintain connectivity for the UEs even under challenging conditions where GNSS signals are unavailable or unreliable, thereby enhancing the reliability of wireless communication. In some examples, by partitioning PRACH resources in the time domain or frequency domain for UEs with and without location information, the described techniques effectively minimize the overlap and potential conflict on resources for different types of UEs, thereby enhancing the overall resource efficiency for wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as κG NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

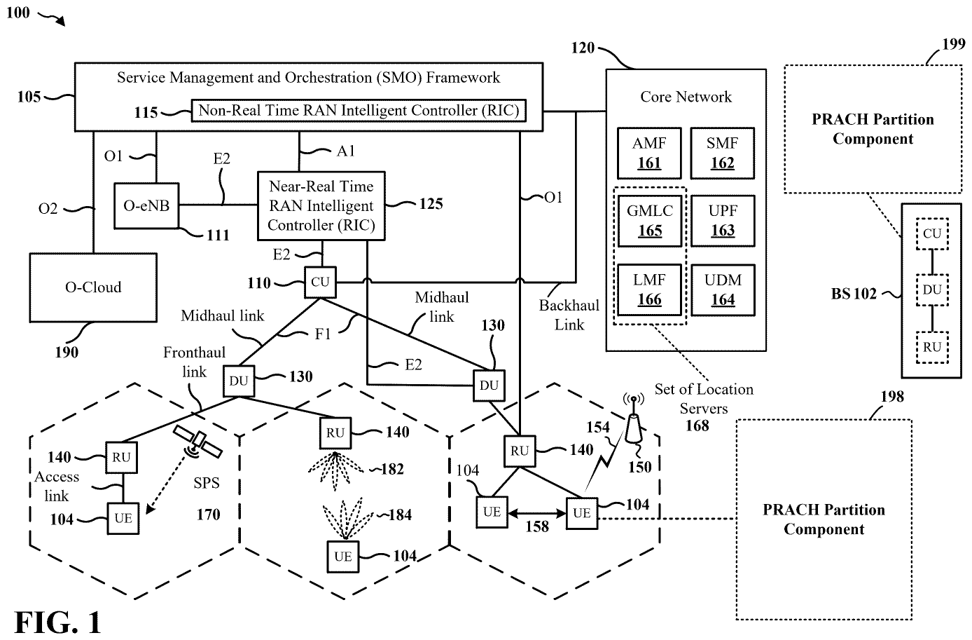

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the PRACH partition component 198. The PRACH partition component 198 may be configured to receive a PRACH configuration from a network entity. The PRACH configuration may indicate a set of PRACH resources for the UE. The PRACH partition component 198 may be further configured to select a PRACH resource from a first PRACH resource and a second PRACH resource in the set of PRACH resources indicated by the PRACH configuration based on the presence or the absence of location information at the UE; and transmit a random access message using the PRACH resource. In certain aspects, the base station 102 may include the PRACH partition component 199. The PRACH partition component 199 may be configured to transmit a PRACH configuration to a UE. The PRACH configuration may indicate a set of PRACH resources, and the set of PRACH resources may include a first PRACH resource for UEs having location information and a second PRACH resource for UEs without the location information. The PRACH partition component 199 may be further configured to receive a random access message from the UE using one of the first PRACH resource or the second PRACH resource. Although the following description may be focused on 5G NR, the concepts described herein may be applicable to other similar areas, such as LTE, LTE-A, CDMA, GSM, and other wireless technologies.

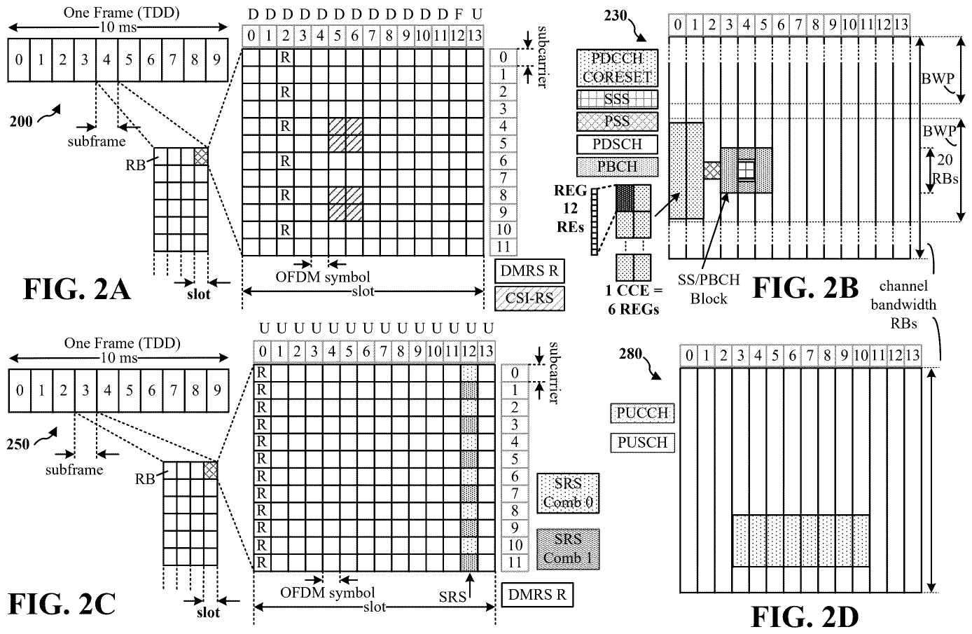

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

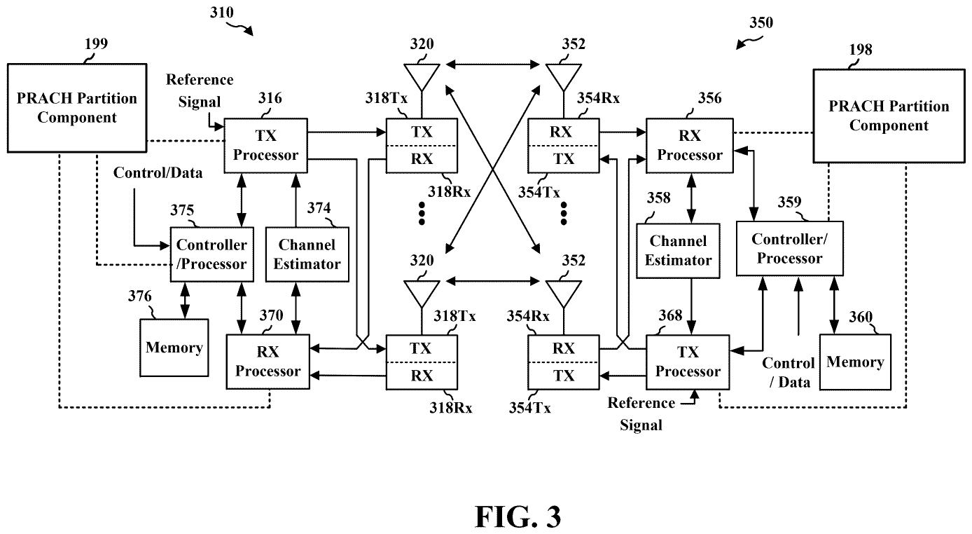

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the PRACH partition component 198 of FIG. 1.

At least one of the TX processor 316, the RX processor 370, and the controller/processor 375 may be configured to perform aspects in connection with the PRACH partition component 199 of FIG. 1.

The NTN (e.g., a network that uses non-terrestrial components, such as satellites, to provide connectivity) may extend wireless coverage to areas that are hard to reach with traditional, terrestrial-based networks, such as remote or rural regions. NTNs currently operate with the expectation that UEs connected to the network possess location information from sources such as GNSS. This expectation, however, makes it difficult for UEs that lack such location information to connect to the NTN. Example aspects presented herein provide methods and apparatus that enhance random access or the PRACH to enable the NTN to differentiate between UEs with and without location information, ensuring those without location information can still effectively connect to the NTN. In some examples, the PRACH enhancements may assist the NTN in distinguishing between GNSS and GNSS-less NTN UEs (e.g., UEs with location information, where the location information is obtained by measuring signals from GNSS, and UEs without location information) and applying different timing and frequency compensation while in a radio resource control (RRC) connected state with the UE. Example aspects presented herein include different ways to distinguish between UEs with and without location information, such as separating the UEs by preamble space, using RO separation, and/or applying frequency domain separation.

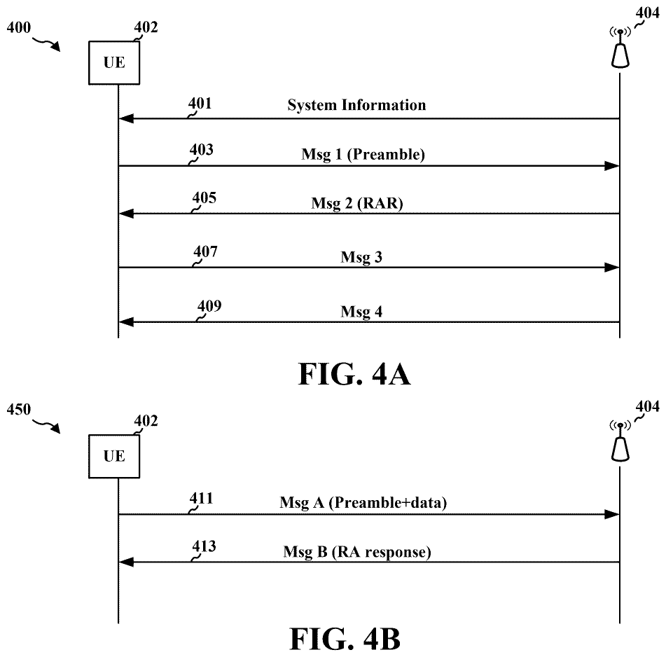

A UE may use a random access procedure in order to communicate with a base station. For example, the UE may use the random access procedure to request an RRC connection, to re-establish an RRC connection, to resume an RRC connection, etc. FIG. 4A illustrates example aspects of a random access procedure 400 between a UE 402 and a base station 404. The UE 402 may initiate the random access message exchange by sending, to the base station 404, a first random access message 403 (e.g., Msg 1) including a preamble. Prior to sending the first random access message 403, the UE 402 may obtain random access parameters, e.g., including preamble format parameters, time and frequency resources, parameters for determining root sequences and/or cyclic shifts for a random access preamble, etc., e.g., in system information 401 from the base station 404. The preamble may be transmitted with an identifier, such as a Random Access RNTI (RA-RNTI). The UE 402 may randomly select a random access preamble sequence, e.g., from a set of preamble sequences. If the UE 402 randomly selects the preamble sequence, the base station 404 may receive another preamble from a different UE at the same time. In some examples, a preamble sequence may be assigned to the UE 402. In some examples, the preamble may be transmitted via a physical random access channel (PRACH) at specific time slots, known as PRACH occasions.

The base station responds to the first random access message 403 by sending a second random access message 405 (e.g., Msg 2) using PDSCH and including a random access response (RAR). The RAR may include, e.g., an identifier of the random access preamble sent by the UE, a time advance (TA), an uplink grant for the UE to transmit data, a cell radio network temporary identifier (C-RNTI) or other identifier, and/or a back-off indicator. Upon receiving the RAR at 405, the UE 402 may transmit a third random access message 407 (e.g., Msg 3) to the base station 404, e.g., using PUSCH, that may include an RRC connection request, an RRC connection re-establishment request, or an RRC connection resume request, depending on the trigger for the initiating the random access procedure. The base station 404 may then complete the random access procedure by sending a fourth random access message 409 (e.g., Msg 4) to the UE 402, e.g., using PDCCH for scheduling and PDSCH for the message. The fourth random access message 409 may include a random access response message that includes timing advancement information, contention resolution information, and/or RRC connection setup information. The UE 402 may monitor for PDCCH, e.g., with the C-RNTI. If the PDCCH is successfully decoded, the UE 402 may also decode PDSCH. The UE 402 may send HARQ feedback for any data carried in the fourth random access message. If two UEs send the same preamble at 403, both UEs may receive the RAR leading both UEs to send a third random access message 407. The base station 404 may resolve such a collision by being able to decode the third random access message from only one of the UEs and responding with a fourth random access message to that UE. The other UE, which did not receive the fourth random access message 409, may determine that random access did not succeed and may re-attempt random access. Thus, the fourth message may be referred to as a contention resolution message. The fourth random access message 409 may complete the random access procedure. Thus, the UE 402 may then transmit uplink communication and/or receive downlink communication with the base station 404 based on the RAR.

In order to reduce latency or control signaling overhead, a single round trip cycle between the UE and the base station 404 may be achieved in a 2-step RACH process 450, such as shown in FIG. 4B. Aspects of Msg 1 and Msg 3 may be combined in a single message, e.g., which may be referred to as Msg A. The Msg A may include a random access preamble, and may also include a PUSCH transmission, e.g., such as data. The MsgA preambles may be separate from the four step preambles, yet may be transmitted in the same ROs as the preambles of the four step RACH procedure or may be transmitted in separate ROs. The PUSCH transmissions may be transmitted in PUSCH occasions (POs) that may span multiple symbols and PRBs. After the UE 402 transmits the Msg A 411, the UE 402 may wait for a response from the base station 404. Additionally, aspects of the Msg 2 and Msg 4 may be combined into a single message, which may be referred to as Msg B. Two step RACH may be triggered for reasons similar to a four-step RACH procedure. If the UE does not receive a response, the UE may retransmit the MsgA or may fall back to a four-step RACH procedure starting with a Msg 1. If the base station detects the Msg A, but fails to successfully decode the Msg A PUSCH, the base station may respond with an allocation of resources for an uplink retransmission of the PUSCH. The UE may fallback to the four step RACH with a transmission of Msg 3 based on the response from the base station and may retransmit the PUSCH from Msg A. If the base station successfully decodes the Msg A and corresponding PUSCH, the base station may reply with an indication of the successful receipt, e.g., as a random access response 413 that completes the two-step RACH procedure. The Msg B may include the random access response and a contention-resolution message. The contention resolution message may be sent after the base station successfully decodes the PUSCH transmission.

An NTN may refer to a wireless communication system that utilizes satellites in order to provide wireless communication services to UEs. In an example, a UE may transmit first data and/or first signal(s) to a satellite via a service link and the satellite may relay the first data and/or the first signal(s) to a network node (e.g., a base station) via a feeder link. In another example, the network node may transmit second data and/or second signal(s) to the satellite via the feeder link and the satellite may relay the second data and/or the second signal(s) to the UE via the service link.

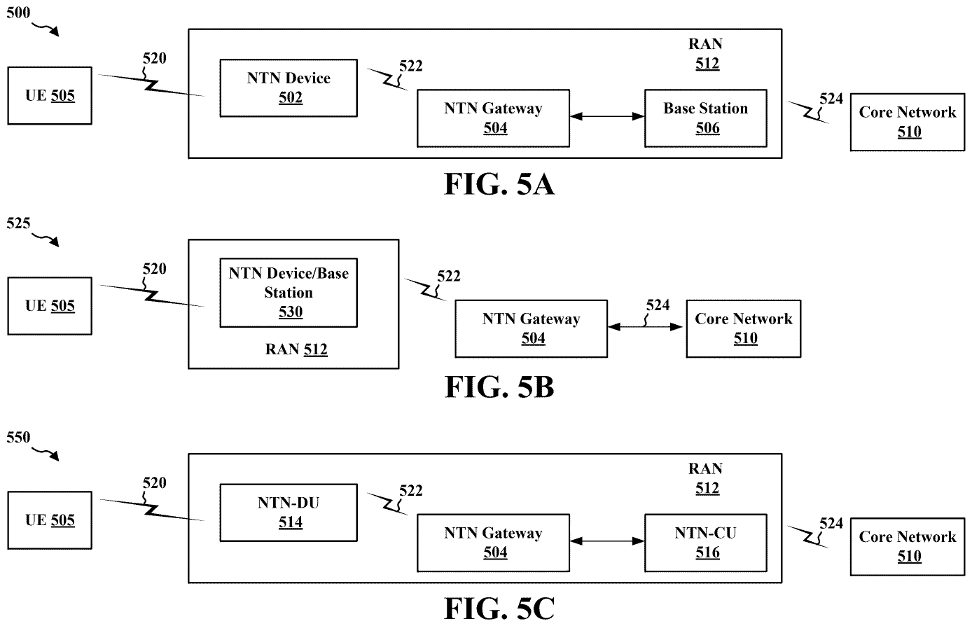

FIGS. 5A, 5B, and 5C illustrate example aspects of various network architecture examples capable of supporting NTN access. FIG. 5A illustrates a network architecture with transparent payloads. The network architecture 500 of FIG. 5A includes a UE 505, an NTN device 502 (which may also be referred to as a satellite, an aerial device, or a space vehicle, among other examples), an NTN gateway 504 (sometimes referred to as “gateway,” “earth station,” or “ground station”), and a base station 506 (which may also be referred to as a network node or network entity) having the capability to communicate with the UE 505 via the NTN device 502. The base station 506 may be a network node or network entity of a terrestrial communication network, for example. A network node may include a base station in aggregation or may correspond to one or more disaggregated components of a base station, such as a CU, DU, and/or RU. The NTN device 502, the NTN gateway 504, and the base station 506 may be part of a RAN 512. As one example, the NTN device 502, the base station 506, and the NTN gateway 504 may be part of an NG RAN, or a RAN for other communication technologies, such as 3G, 4G LTE, 6G, etc. The network architecture 500 is illustrated as further including a core network 510, which may correspond to the core network (e.g., 160, 190, 220) described in connection with FIG. 1. A core network 510 may be a public land mobile network (PLMN), for example. Connections in the network architecture 500 with transparent payloads illustrated in FIG. 5A, allow the base station 506 to access the NTN gateway 504 and the core network 510. In some examples, the base station 506 may be shared by multiple PLMNs. Similarly, the NTN gateway 504 may be shared by more than one base station. Although the examples of FIG. 5A, FIG. 5B, and FIG. 5C illustrate one UE 505, many UEs may utilize the network architecture 500. Similarly, the network architecture 500 may include a larger (or smaller) number of NTN devices, NTN gateways, base stations, RAN, core networks, and/or other components. The illustrated connections that connect the various components in the network architecture 500 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 505 may be configured to communicate with the core network 510 via the NTN device 502, the NTN gateway 504, and the base station 506. As illustrated by the RAN 512, one or more RANs associated with the core network 510 may include one or more base stations. Access to the network may be provided to the UE 505 via wireless communication between the UE 505 and the base station 506 (e.g., a serving base station), via the NTN device 502 and the NTN gateway 504.

The base station 506 may be referred to by other names such as a network node, a network entity, a gNB, a “satellite node”, a satellite NodeB (sNB), “satellite access node”, etc. The base station 506 in FIG. 5A may be different than a terrestrial network base station, in some aspects, such as supporting additional capability beyond that of a terrestrial base station. For example, the base station 506 may terminate the radio interface and associated radio interface protocols to the UE 505 and may transmit DL signals to the UE 505 and receive UL signals from the UE 505 via the NTN device 502 and the NTN gateway 504. The base station 506 may also support signaling connections and voice and data bearers to the UE 505 and may support handover of the UE 505 between different radio cells for the NTN device 502, between different NTN devices and/or between different base stations. The base station 506 may be configured to manage moving radio beams (e.g., for airborne vehicles and/or non-geostationary (non-GEO) devices) and associated mobility of the UE 505. The base station 506 may assist in the handover (or transfer) of the NTN device 502 between different NTN gateways or different base stations. Additionally, a coverage area of the base station 506 may be much larger than the coverage area of a terrestrial network base station. In some examples, the base station 506 may be separate from the NTN gateway 504, e.g., as illustrated in the example of FIG. 5A. In other examples, the base station 506 may include or may be combined with one or more NTN gateways, e.g., using a split architecture. For example, with a split architecture, the base station 506 may include a CU, such as the example CU 110 of FIG. 1, and the NTN gateway 504 may include or act as (DU, such as the example DU 130 of FIG. 1. The base station 506 may be fixed on the ground for transparent payload operation. In one implementation, the base station 506 may be physically combined with, or physically connected to, the NTN gateway 504 to reduce complexity and cost.

The NTN gateway 504 may be shared by more than one base station and may communicate with the UE 505 via the NTN device 502. The NTN gateway 504 may be dedicated to one associated constellation of NTN devices. The NTN gateway 504 may be included within the base station 506, e.g., as a base station-DU within the base station 506.

In the illustrated example of FIG. 5A, a service link 520 may facilitate communication between the UE 505 and the NTN device 502, a feeder link 522 may facilitate communication between the NTN device 502 and the NTN gateway 504, and an interface 524 may facilitate communication between the base station 506 and the core network 510. The service link 520 and the feeder link 522 may be implemented by a same radio interface (e.g., a Uu interface).

FIG. 5B shows a diagram of a network architecture 525 capable of supporting NTN access similar to FIG. 5A, but having a network architecture for regenerative payloads, as opposed to transparent payloads shown in FIG. 5A. A regenerative payload, unlike a transparent payload, includes an on-board base station (e.g., includes the functional capability of a base station), and is referred to herein as an NTN device/base station 530. The on-board base station may be a network node that corresponds to the network device (e.g., 102 in FIG. 1, base station 310 in FIG. 3). The RAN 512 is illustrated as including the NTN device/base station 530 for communication with the UE 505 and the core network 510.

An on-board base station may perform many of the same functions as the base station 506, as described previously. For example, the NTN device/base station 530 may terminate the radio interface and associated radio interface protocols to the UE 505 and may transmit DL signals to the UE 505 and receive UL signals from the UE 505, which may include encoding and modulation of transmitted signals and demodulation and decoding of received signals. The NTN device/base station 530 may communicate with one or more NTN gateways and with one or more core networks via the NTN gateway 504. In some aspects, the NTN device/base station 530 may communicate directly with other NTN device/base stations using Inter-Satellite Links (ISLs), which may support an Xn interface between any pair of NTN device/base stations.

With low Earth orbit (LEO) devices, the NTN device/base station 530 may manage moving radio cells with coverage at different times. The NTN gateway 504 may be connected directly to the core network 510, as illustrated. The NTN gateway 504 may be shared by multiple core networks, for example, if NTN gateways are limited. In some examples the core network 510 may be aware of the coverage area(s) of the NTN device/base station 530 in order to page the UE 505 and to manage handover.

FIG. 5C shows a diagram of a network architecture 550 similar to that shown in FIGS. 5A and 5B, which support regenerative payloads as opposed to transparent payloads, as shown in FIG. 5A, and with a split architecture for the base station. For example, the base station may be split between a CU (e.g., such as CU 110 of FIG. 1), and a DU (e.g., such as the DU 130 of FIG. 1). In the illustrated example of FIG. 5C, the network architecture 550 includes an NTN-CU 516, which may be a component of a ground-based base station or a terrestrial base station. The regenerative payloads include an on-board base station DU, and is referred to herein as an NTN-DU 514. The NTN-CU 516 and the NTN-DU 514, collectively or individually, may correspond to the network node associated with the network device (e.g., base station 310) in FIG. 3.

The NTN-DU 514 communicates with the NTN-CU 516 via the NTN gateway 504. The NTN-CU 516 together with the NTN-DU 514 perform functions, and may use internal communication protocols, e.g., based on a split architecture. The NTN-CU 516 and the NTN-DU 514 may each support additional capabilities to provide the UE 505 access using NTN devices.

The NTN-DU 514 and the NTN-CU 516 may communicate with one another using an F1 Application Protocol (F1AP), and together may perform some or all of the same functions as the base station 506 or the NTN device/base station 530 as described in connection with FIGS. 5A and 5B, respectively.

The NTN-DU 514 may terminate the radio interface and associated lower level radio interface protocols to the UE 505 and may transmit DL signals to the UE 505 and receive UL signals from the UE 505, which may include encoding and modulation of transmitted signals and demodulation and decoding of received signals. The operation of the NTN-DU 514 may be partly controlled by the NTN-CU 516. The NTN-DU 514 may support one or more radio cells for the UE 505. The NTN-CU 516 may also be split into separate control plane (CP) (NTN-CU-CP) and user plane (UP) (NTN-CU-UP) portions. The NTN-DU 514 and the NTN-CU 516 may communicate over an F1 interface to (a) support control plane signaling for the UE 505 using IP, Stream Control Transmission Protocol (SCTP) and F1 Application Protocol (F1AP) protocols, and (b) to support user plane data transfer for a UE 505 using IP, User Datagram Protocol (UDP), PDCP, SDAP, GTP-U and NR User Plane Protocol (NRUPP) protocols.

The NTN-CU 516 may communicate with one or more other NTN-CUs and/or with one more other terrestrial base stations using terrestrial links to support an Xn interface between any pair of NTN-CUs and/or between the NTN-CU 516 and a terrestrial base station.

A UE connected to an NTN may possess location information (e.g., may have received location information), such as information from a GNSS. The UE may use the location information, e.g., the received GNSS, to facilitate the UE's connection with NTNs. On the other hand, the capability to connect to a UE that lacks location information provides various potential use cases, including emergency or disaster response and applications in light indoor or in-vehicle environments. The ability to establish NTN connections without location information (e.g., without GNSS information) may function as a supplementary or alternative connectivity solution when a UE is not able to obtain location information. For example, when the location information is available, the NTN may provide efficient and high-performance connections to the UE, taking advantage of the location information. In scenarios where the location information becomes unavailable or unreliable, the NTN may still provide resilient services to UEs, even without such information.

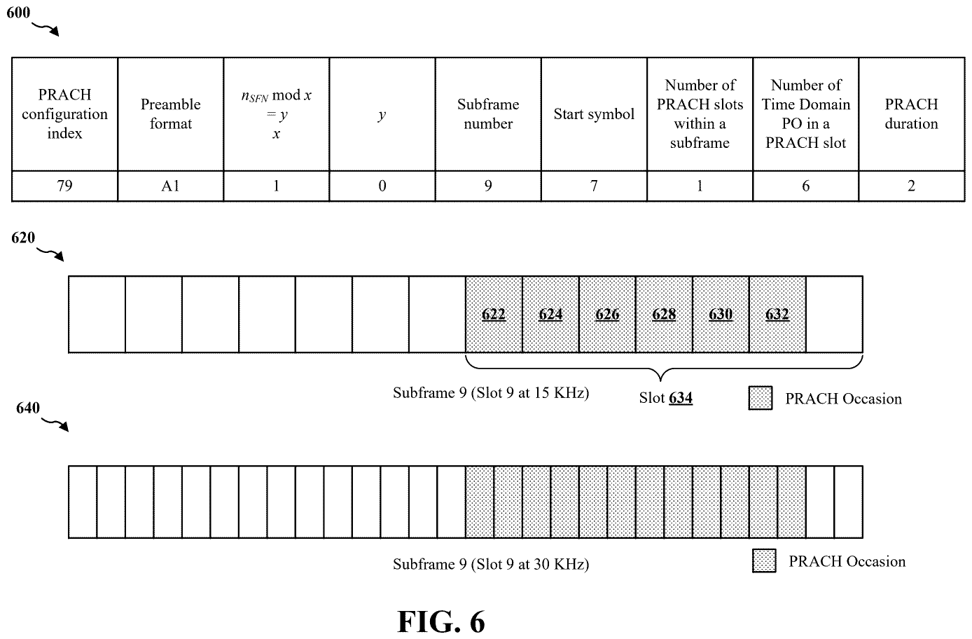

A UE may transmit a random access message, such as Msg 1 or Msg A described in FIG. 4A and FIG. 4B, in a PRACH occasion, e.g., a time resource or time occasion for PRACH transmissions. In some aspects, the UE may determine the time and/or frequency resources for PRACH occasions from system information, e.g., such as 401 in FIG. 4A. In the time domain, various configurations may be used in PRACH occasions. FIG. 6 shows diagrams illustrating example PRACH configurations. In the example shown in FIG. 6, diagram 600 shows a PRACH configuration indicating one PRACH slot per subframe, with six time-domain ROs in a PRACH slot. Diagram 620 shows example ROs (e.g., RO 622, 624, 626, 628, 630, 632) within a PRACH slot (e.g., slot 634) in a subframe, corresponding to the PRACH configuration in diagram 600. Diagram 640 shows another set of example ROs, where the subcarrier spacing is doubled compared to diagram 620 (e.g., 30 KHz in diagram 640 versus 15 KHz in diagram 620).

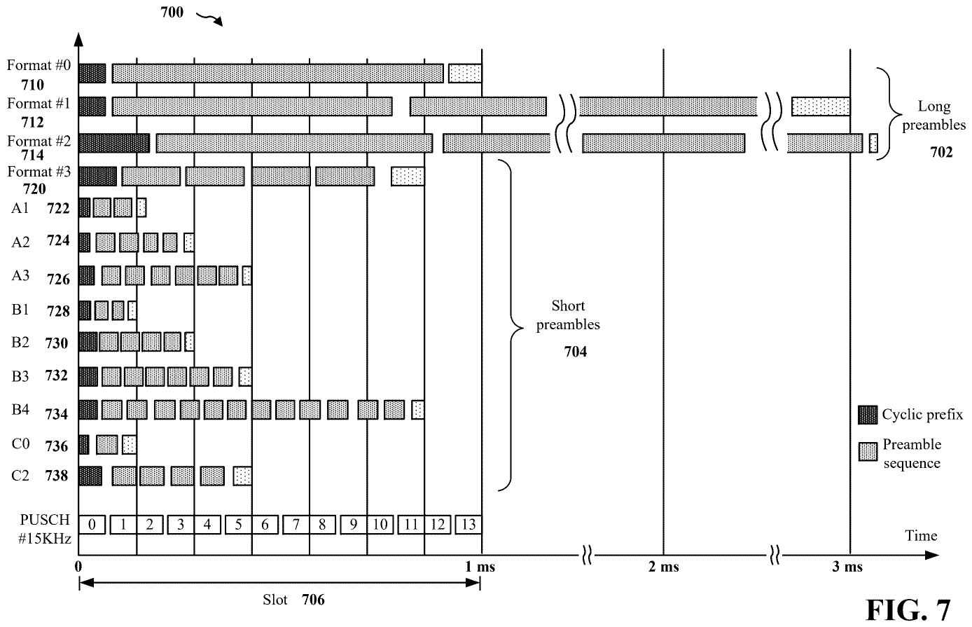

The PRACH format (e.g., the format of the preamble signal in a Msg 1 or Msg A transmission) in wireless communication may include two formats: long and short. Each format may have different lengths and configurations for various components of the PRACH preambles, such as the cyclic prefix, preamble sequences. FIG. 7 is a diagram 700 illustrating example PRACH preamble structures. As shown in FIG. 7, the long format of PRACH preambles (e.g., long preambles 702) may span across 1 to 3 slots. The long format may include Format #0 710, Format #1 712, Format #2 714. On the other hand, the short format of PRACH preambles (e.g., short preambles 704) may span multiple symbols within a single slot (e.g., slot 706). The short format may include Format #3 720, A1 722, A2 724, A3 726, B1 728, B2 730, B3 732, B4 734, C0 736, C2 738.

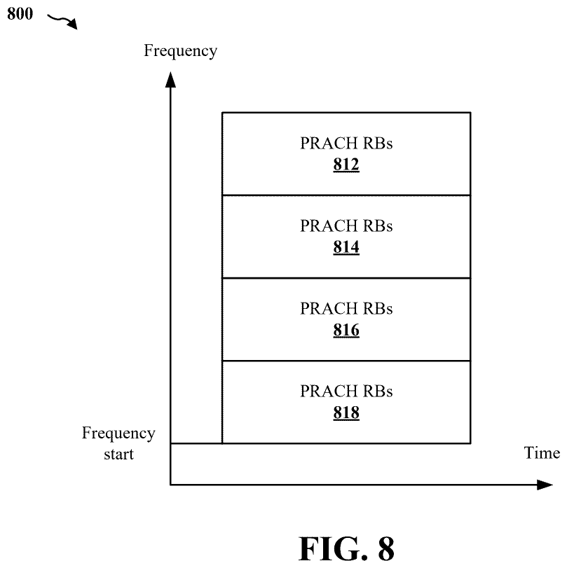

The random access message may also be transmitted in frequency resources for PRACH transmissions. In the frequency domain, various configurations may be used in PRACH occasions. In some examples, eight frequency resources may be available for the transmission of msg1 for the PRACH process (e.g., parameter msg1-FDM may be set at 8). The number of synchronization signal blocks (SSBs) may be eight (e.g., labeled from 0 to 7), and the number of SSBs per PRACH occasion and the number of contention-based (CB) preambles per SSB may be set to one. In some examples, eight frequency resources may be available for the transmission of msg1 for the PRACH process (e.g., parameter msg1-FDM may be set at 8), but the number of synchronization signal blocks (SSBs) may be four (e.g., labeled from 0 to 3), and the number of SSBs per PRACH occasion and the number of CB preambles per SSB may be set to one-fourth. FIG. 8 is a diagram 800 illustrating another example of PRACH occasions in the frequency domain. As shown in FIG. 8, in some examples, four frequency resources (e.g., PRACH RBs 812, 814, 816, 818) may be available for the transmission of msg1 for the PRACH process (e.g., parameter msg1-FDM may be set at 4). The number of synchronization signal blocks (SSBs) may be four (e.g., labeled from 0 to 3), and the number of SSBs per PRACH occasion and the number of CB preambles per SSB may be set to four or sixteen. In some examples, these configurations enable the network, such as the base station, to implicitly determine the association of each SSB based on their frequency location.

In wireless communication, there may be a mapping relationship between the SSB and the RO, which may also be referred to as a physical random access occasion (PO) in some aspects. As used herein, the terms “random access channel occasion” (RO) and “physical random access channel occasion” (PO) may be used interchangeably. In Type-1 random access procedures in wireless communication, such as those shown in FIG. 4A, a UE may be provided the number (e.g., N) of synchronized signal (SS) or physical broadcast channel (PBCH) block indexes associated with one PRACH occasion and the number (e.g., R) of contention-based preambles for each SS/PBCH block index per valid PRACH occasion, as defined by the field ssb-perRACH-OccasionAndCB-PreamblesPerSSB in a PRACH configuration (e.g., the RACH-ConfigCommon configuration). This field may indicate two parameters: CB-preambles-per-SSB and SSB-per-rach-occasion. For example, a CB-preambles-per-SSB value of “⅛” may indicate that one SSB is associated with eight ROs. Thus, within any given RO, the total number of random access (RA) preambles may be partitioned by parameter CB-preambles-per-SSB. As an example, the number of preambles may be the product of the number of SSBs per RO and the number of preambles per SSB, not exceeding 64.

As a non-limiting example, the maximum number of PRACH sequences for a UE to use in a cell may be 64. As an example, the PRACH sequences may be generated based on a Zadoff-Chu sequence, which is generated using a rootSequenceIndex (also referred to as “PRACH root” in some aspects) and may be referred to as the “base sequence.” Cyclic shifts may be applied to this base sequence to create 64 unique sequences, for example. In some examples, each shift applied to the base sequence may be an integer multiple of a base amount, known as the cyclic shift interval (N_{CS}). If the UE exhausts all sequences by applying the cyclic shifts on the base sequence, it increases the root and then starts applying cyclic shifts.

In some examples, if all of the SSBs cannot be mapped to the sequences in a single RO, then the SSBs may be mapped to other ROs in different frequencies and times (e.g., in symbols and slots). This mapping process may follow an order. Initially, the SS/PBCH block indexes, as provided by the parameter ssb-PositionslnBurst in system information block 1 (SIB1) or parameter ServingCellConfigCommon, may be mapped to valid PRACH occasions. The mapping order may begin with an increasing order (e.g., ascending order) of the preamble indexes within a single PRACH occasion, followed by an increasing order (e.g., ascending order) of the frequency resource indexes for frequency multiplexed PRACH occasions, followed by an increasing order (e.g., ascending order) of the time resource indexes for time multiplexed PRACH occasions within a single PRACH slot. Lastly, the mapping order continues with an increasing order (e.g., ascending order) of the indexes for PRACH slots.

The NTNs currently operate with the expectation that UEs connected to the network possess location information from sources such as GNSS, based on which the UE may apply timing and frequency corrections during uplink transmissions, including PRACH, physical uplink control channel (PUCCH), physical uplink shared channel (PUSCH), and sounding reference signal (SRS) processes. Example aspects presented herein provide methods and apparatus that improve random access by enabling UEs without location information to access the NTN and enabling the NTN to distinguish between UEs that have location information and UEs without location information. Aspects include the partitioning of random access resources to enable the NTN to differentiate between UEs with location information and those without location information, helping to ensure that UEs without location information (e.g., GNSS-less UE) can effectively connect to the NTN. A GNSS is one, non-limiting example of a source of location information for UEs with location information. As used herein, the term “GNSS UEs,” may be used as an example of UEs with location information, and the term “GNSS-less UEs” may be used as an example of UEs without location information. As an example, the network may use a single PRACH resource configuration that can be shared between GNSS UEs and GNSS-less UEs, and partition these resources across time, frequency, and sequence domains to accommodate the varying needs or capabilities of both types of UEs.

In some aspects, to optimize the use of PRACH resources in NTN, GNSS UEs may use a first set of PRACH root and cyclic shifts, and GNSS-less UEs may use a second set of PRACH root and cyclic shifts within the same PRACH occasion.

In some examples, a set of random access preambles x_{u,v}(n) may be generated according to:

$${x}_{u , v} ( n ) = {x}_{u} ( ( n + {C}_{v} ) mod {L}_{RA} ) \qquad ( 1 )$$

$${x}_{u} ( i ) = {e}^{- j \frac{π ui ( i + 1 )}{{L}_{RA}}} , i = 0 , 1 , … , {L}_{RA}$$

from which the frequency domain representation may be generated according to:

$${y}_{u , v} ( n ) = {\sum }_{m = 0}^{{L}_{RA} - 1} {x}_{u , v} ( m ) \cdot {e}^{- j \frac{2 π mn}{{L}_{RA}}} \qquad ( 2 )$$

where L_{RA} may have various values, such as 139, 571, 839, or 1151, depending on the PRACH preamble format (e.g., Format #0 710, Format #1 712, Format #2 714, Format #3 720, A1 722).

In some examples, 64 preambles may be defined in each time-frequency PRACH occasion, enumerated in increasing order (e.g., ascending order) of first increasing cyclic shift Cᵥ of a logical root sequence, and then in increasing order (e.g., ascending order) of the logical root sequence index, starting with the index obtained from the higher-layer parameter prach-RootSequenceIndex or rootSequenceIndex-BFR or by msgA-PRACH-RootSequenceIndex if configured and a Type-2 random-access procedure (e.g., the procedure shown in FIG. 4B) is initiated.

In some examples, when 64 preambles cannot be generated from a single root Zadoff-Chu sequence, additional preamble sequences may be obtained from the root sequences with the consecutive logical indexes until all the 64 sequences are found. The logical root sequence order is cyclic, and the logical index 0 is consecutive to L_{RA}−2.

In some examples, the sequence number u may be obtained from the logical root sequence index. The cyclic shift Cᵥ may be given by:

$$( 3 )$$

$${C}_{v} = \{ \begin{matrix}\begin{matrix}\begin{matrix}{vN}_{CS} , v = 0 , 1 , … , ⌊ \frac{{L}_{RA}}{{N}_{CS}} ⌋ - 1 , {N}_{CS} \neq 0 & for unrestricted sets\end{matrix} \\ \begin{matrix}0 , {N}_{CS} \neq 0 , & for unrestricted sets\end{matrix}\end{matrix} \\ \begin{matrix}{d}_{start} ⌊ \frac{v}{{n}_{shift}^{RA}} ⌋ + ( v mod {n}_{shift}^{RA} ) {N}_{CS} , & v = 0 , 1 , … , w - 1\end{matrix} \\ for restricted sets type A and B \\ {\overline{\overline{d}}}_{start} + ( v - w ) {N}_{CS} , v = w , … , w + {\overline{\overline{n}}}_{shift}^{RA} - 1 \\ for restricted sets type B \\ {\overline{\overline{\overline{d}}}}_{start} + ( v - w - {{\overline{\overline{n}}}_{shift}^{RA}}_{} ) {N}_{CS} , v = w + {\overline{\overline{n}}}_{shift}^{RA} , … , w + {\overline{\overline{n}}}_{shift}^{RA} + {\overline{\overline{\overline{n}}}}_{shift}^{RA} - 1 \\ for restricted sets type B\end{matrix}$$

where

$$w = {n}_{shift}^{RA} {n}_{group}^{RA} + {\overline{n}}_{shift}^{RA} ,$$

and the cyclic shift interval (e.g., N_{CS}) may have a predetermined value (e.g., a value provided by wireless communication standards). The type of restricted sets in Equation (3) (e.g., unrestricted, restricted type A, restricted type B) is given by the higher-layer parameters such as msgA-RestrictedSetConfig (if provided), ltm-RestrictedSetConfig associated with a candidate cell indicated in cell indicator field of a PDCCH order, or parameter restrictedSetConfig if no other parameters are provided. The supported types of restricted sets for different preamble formats may be provided in advance (e.g., provided in wireless communication standards).

In some examples, GNSS-less UEs may have a different restricted set definition (e.g., a new set of cyclic shifts Cᵥ, as defined in Equation (3)) than the GNSS UEs. In some examples, the GNSS-less UEs may select the sequence number u from one set, and GNSS UEs may select the sequence number u from a different set, so that the selections from GNSS UEs and GNSS-less UEs do not conflict (or overlap) with each other.

In some aspects, the CP gap length may be different for the different UEs. For example, a longer CP gap length may be used for GNSS-less UEs, as they may experience more uncertainty based on the lack of location information. The UEs with location information, e.g., GNSS UEs, may use a shorter CP gap length.

In some aspects, GNSS UEs and GNSS-less UEs may use a shared PRACH configuration (e.g., the RACH-ConfigCommon configuration) in an NTN. In some examples, GNSS UEs and GNSS-less UEs may use one SSB and may be signaled to have parameter ssb-perRACH-Occasion set at one and parameter PreamblesPerSSB set at n32. To accommodate GNSS and GNSS-less UEs within the same network configuration, GNSS UEs may use the first thirty-two preamble sequences (from the 1^{st} to the 32^{nd} preamble sequence), and GNSS-less UEs may start from the 33rd preamble sequence up to the 64th. Additionally, GNSS-less UEs may also be signaled a distinct zero-correlation-zone (e.g., N_{CS} in Equation (3)) inside the shared PRACH configuration (e.g., the RACH-ConfigCommon configuration). This signaling adjustment provides further differentiation in the access strategy between GNSS UEs and GNSS-less UEs.

In some aspects, GNSS and GNSS-less UEs may share a common PRACH configuration while managing resource partitioning over the time domain. For example, GNSS and GNSS-less UEs may be assigned different ROs to avoid conflicts and optimize the utilization of PRACH resources. This partitioning may be specified in advance (e.g., in wireless communication standards) by a set of rules. For example, if GNSS and GNSS-less UEs are deriving PRACH occasions from a common PRACH resources (e.g., based on configuration RACH-ConfigGeneric-rXX), GNSS UEs may be configured to access PRACH occasions in even subframes, while GNSS-less UEs may be configured to access PRACH occasions in odd subframes. In some examples, a more complex pattern may be used. For example, GNSS UEs may access a sequence of three subframes starting with an even subframe (e.g., subframes 3n, 3n+1, 3n+2, where n is an even number), and GNSS-less UEs may access another sequence of three subframes starting with an odd subframe (e.g., subframes 3n, 3n+1, 3n+2, where n is an odd number).

For example, with PRACH format 19 where PRACH occasions are in every 1^{st} and 6^{th} subframe, GNSS UEs may use the 1^{st} subframe, and GNSS-less UEs may use the 6^{th} subframe. In some examples, the time division multiplexing (TDM) pattern used to differentiate the access between GNSS and GNSS-less UEs may be indicated by network signaling. For example, the network may indicate that the GNSS UEs use ROs in even subframes and GNSS-less UEs use ROs in odd subframes.

In some aspects, GNSS and GNSS-less UEs may share a common PRACH configuration while managing resource partitioning over the frequency domain. In some aspects, GNSS and GNSS-less UEs may use different ROs in the frequency domain. For example, if the parameter msg1-FDM is set to N, meaning N ROs are frequency division multiplexed in each symbol, GNSS UEs and GNSS-less UEs may follow different mapping rules when mapping SSBs to these ROs. For example, GNSS UEs may map the SSBs to ROs in an increasing order (e.g., ascending order) of the frequency-multiplexed ROs, starting from the RO in the lowest available frequencies and moving upward. On the other hand, GNSS-less UEs may map the SSBs to ROs in a decreasing order (e.g., descending order), starting from the RO in the highest available frequencies and moving downward.

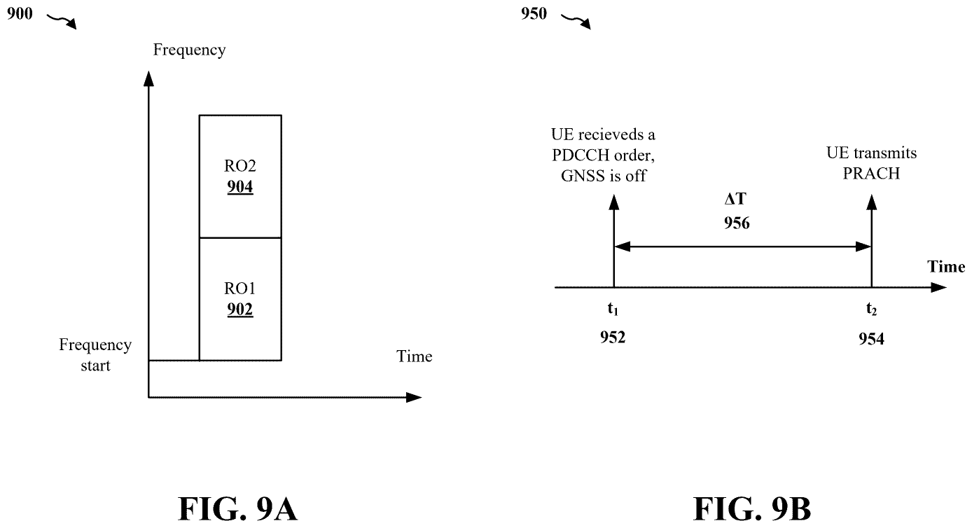

FIG. 9A is a diagram 900 illustrating an example of the utilization of different ROs in the frequency domain in accordance with various aspects of the present disclosure. In the example in FIG. 9A, the parameter msg1-FDM is set to 2, meaning 2 ROs (e.g., RO1 902 and RO2 904) are frequency division multiplexed in each symbol. In this case, the GNSS UE may utilize RO1 902, positioned at the lower frequency, while the GNSS-less UE may utilize RO2 904, positioned at the higher frequency. These two ROs (e.g., RO1 902 and RO2 904) may not overlap on the frequency domain. This strategy ensures that both types of UEs (e.g., GNSS UEs and GNSS-less UEs) may access the network efficiently without interference with each other.

In some examples, when one SSB is available, both types of UEs (e.g., GNSS UEs and GNSS-less UEs) may share a common PRACH configuration. GNSS UEs may be signaled that each RACH occasion corresponds to one SSB (e.g., parameter ssb-perRACH-Occasion is set to 1), and the parameter msg1-FDM (e.g., as part of the parameter RACH-ConfigGeneric) may be set to 2, meaning that 2 ROs are frequency division multiplexed in each symbol. As a result, the GNSS UEs may not use the second RO, denoted as RO2, leaving it available for other uses (e.g., use by GNSS-less UEs). On the other hand, GNSS-less UEs are also indicated that each RACH occasion corresponds to one SSB (e.g., with ssb-perRACH-Occasion set to 1) and 2 ROs are frequency division multiplexed in each symbol (e.g., with msg1-FDM set to 2). In some examples, the GNSS-less UEs may be additionally signaled to use the other available RO (e.g., RO2). In some examples, this additional signaling to the GNSS-less UEs may be implemented in various ways. For example, the GNSS-less UEs may be additionally signaled with the start index of the frequency division multiplexed RO for the SSB-RO mapping for GNSS-less UEs.

In some aspects, separate RACH resources may be allocated for UEs that lack GNSS (e.g., GNSS-less UEs) and those that have GNSS information (e.g., GNSS UEs). In some aspects, a UE may be configured to access two different RACH resource pools. For example, the first RACH resource pool may be designated for GNSS-less operations, and the second RACH resource pool may be designated for GNSS-based operations. In some examples, the PDCCH order may then indicate which pool is to be used for the PRACH transmission. If the PDCCH order indicates the use of the GNSS-less pool (e.g., the first RACH resource pool), the UE will not acquire GNSS information (e.g., GNSS signals) prior to the PRACH transmission (or the UE may transmit PRACH transmissions independent of GNSS acquisition or without GNSS acquisition, which may be referred to as a GNSS-less mode). On the other hand, if the PDCCH order indicates the use of the GNSS pool (e.g., the second RACH resource pool), the UE first acquires the GNSS information (e.g., GNSS signals) before transmitting a PRACH transmission.

In some scenarios, when a GNSS-capable UE (e.g., a GNSS UE) is operating in a GNSS-less mode, it may receive control signaling (e.g., which may be referred to as a PDCCH order or PDCCH signaling) for a PRACH transmission that includes resources for GNSS operations (e.g., the PRACH may be a PRACH that includes resources for both GNSS-less UE or GNSS UE or a PDCCH order that does not distinguish between GNSS and GNSS-less UEs) during a particular subframe (e.g., subframe n). The UE may wait for a minimum time period, e.g., which may be denoted as ΔT, after receiving the control signaling (e.g., PDCCH order) before considering the PRACH occasion. This minimum time period, ΔT, may include the time for acquiring GNSS information (e.g., acquiring GNSS signals). FIG. 9B is a diagram 950 illustrating an example of the minimum time period between a PDCCH order and a PRACH transmission in accordance with various aspects of the present disclosure. As shown in FIG. 9B, a GNSS-capable UE (e.g., a GNSS UE) may operate in a GNSS-less mode. At time t₁ 952, the UE receives a PDCCH order for a PRACH transmission that includes resources for GNSS operations. The UE may wait for a minimum time period (e.g., ΔT 956) before it can start the PRACH transmission at time t₂ 954. The minimum time period (e.g., ΔT 956) may be equal to or larger than the time necessary for the UE to acquire GNSS information (e.g., acquiring GNSS signals).

In some aspects, the RACH resources may be shared between GNSS-less UEs and GNSS UEs, based on additional resource sharing rules for sharing resources across the time domain, frequency domain, or sequence domain. In some aspects, a GNSS-capable UE (e.g., GNSS UE) may receive a new PDCCH order. This PDCCH order may indicate to the UE to either reacquire the GNSS information (e.g., GNSS signals) before transmitting the PRACH in response to the PDCCH order or proceed without changing its GNSS state before transmitting the PRACH.

In some examples, a GNSS-capable UE (e.g., GNSS UE) may receive a new PDCCH order that indicates that the UE can transmit the PRACH without changing its GNSS state. Upon receiving this PDCCH order, the UE may derive the ROs using the SSB-to-RO mapping rules reserved for GNSS-less random access. In scenarios involving contention-based random access with the same PDCCH order, the UE may use a different cyclic shift and PRACH sequence partition reserved for GNSS-less random access, which may be configured according to a cell-specific RACH configuration, such as a cell-specific RACH-ConfigGeneric.

In some aspects, if the UE is transmitting PRACH in response to a PDCCH order during the GNSS-less state (e.g., when the GNSS information is unavailable to the UE), the UE may apply a UE-adjusted time-frequency pre-compensation to the PRACH resource. The amount of time-frequency pre-compensation may be obtained based on various factors. In some examples, the UE may obtain the pre-compensation based on the DCI carrying the PDCCH order, where the DCI may include additional bits that indicate the timing and frequency pre-compensation. In some examples, the UE may obtain the pre-compensation based on the accumulated time and frequency adjustments. For example, the UE may use the accumulated time and frequency adjustments to derive the time-frequency pre-compensation. In some examples, the UE may obtain the time-frequency pre-compensation based on a cell-specific Timing Advance (TA) or Frequency Adjustment (FA) value, which may be indicated via a system information block (SIB). In some examples, the UE may obtain the time-frequency pre-compensation based on a dedicated TA or FA value, which may be indicated via RRC signaling.

In some aspects, the network may issue PDCCH orders with additional instructions about the GNSS state. In some examples, the additional instructions about the GNSS state may be based on the UE's indication of whether it can support GNSS or GNSS-less operations. In some examples, the additional instructions about the GNSS state may be based on the network's tracking of the UE's most recent GNSS state.

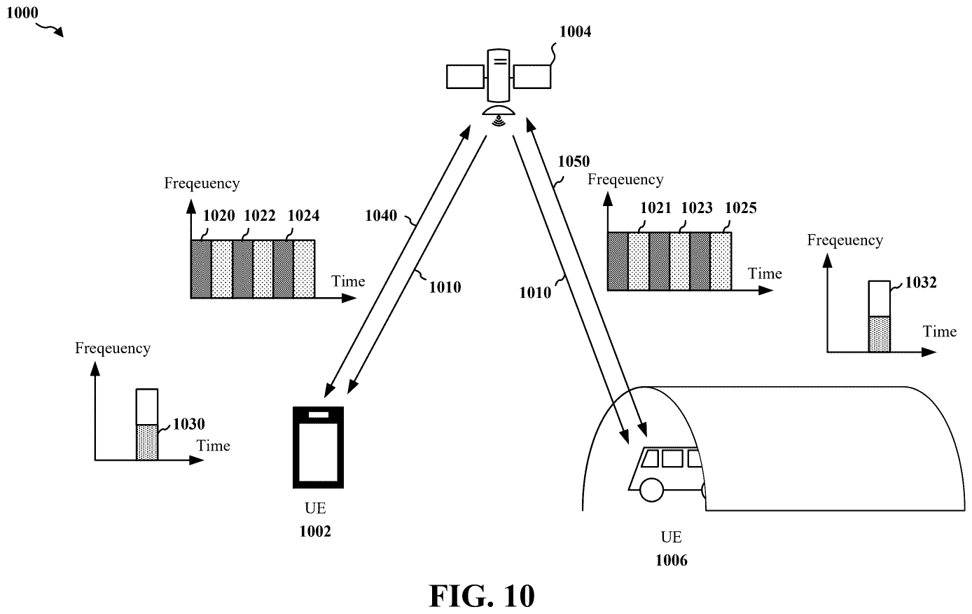

FIG. 10 is a diagram 1000 illustrating an example of PRACH partitioning for different types of UEs (e.g., GNSS UEs or GNSS-less UEs) in accordance with various aspects of the present disclosure. As shown in FIG. 10, the NTN (e.g. the satellite 1004) may, at 1010, transmit a PRACH configuration that indicates a set of PRACH resources for UEs. The UE may include UE 1002 and UE 1006. As an example, UE 1002 may possess location information (e.g., GNSS information) and may be GNSS UE, and UE 1006 may lack location information (e.g., due to GNSS signal blockage in a tunnel) and may be GNSS-less UE. Based on the PRACH configuration, the UEs (e.g., GNSS UE 1002 and GNSS-less UE 1006) may select the appropriate PRACH resources from the set of PRACH resources for communication with the NTN (e.g., satellite 1004) depending on the availability of the location information.

In some examples, GNSS UE 1002 and GNSS-less UE 1006 may select different PRACH resources in the time domain. For example, the GNSS UE 1002 may select the PRACH resources in a first set of subframes (e.g., even subframes), while GNSS-less UE 1006 may select the PRACH resources in a second set of subframes (e.g., odd subframes) different from the first set of subframes.

In some examples, GNSS UE 1002 and GNSS-less UE 1006 may use different mapping rules to map SSBs and ROs, allowing them to select different ROs in the frequency domain. For example, when two ROs are available for one SSB, GNSS UE 1002 may map the SSBs to ROs in an increasing order (e.g., ascending order) of the frequency-multiplexed ROs, starting from the RO in the lowest available frequencies and moving upward, and GNSS-less UE 1006 may map the SSBs to ROs in a decreasing order (e.g., descending order), starting from the RO in the highest available frequencies and moving downward. As a result, the GNSS UE 1002 may select RO 1030, and GNSS-less UE 1006 may select RO 1032. Based on the selected PRACH resources, GNSS UE 1002 and GNSS-less UE 1006 may communicate with the NTN (e.g., satellite 1004) at 1040 and 1050, respectively. For example, GNSS UE 1002 and GNSS-less UE 1006 may transmit a random access message to the NTN (e.g., satellite 1004) using the selected PRACH resources at 1040 and 1050, respectively.

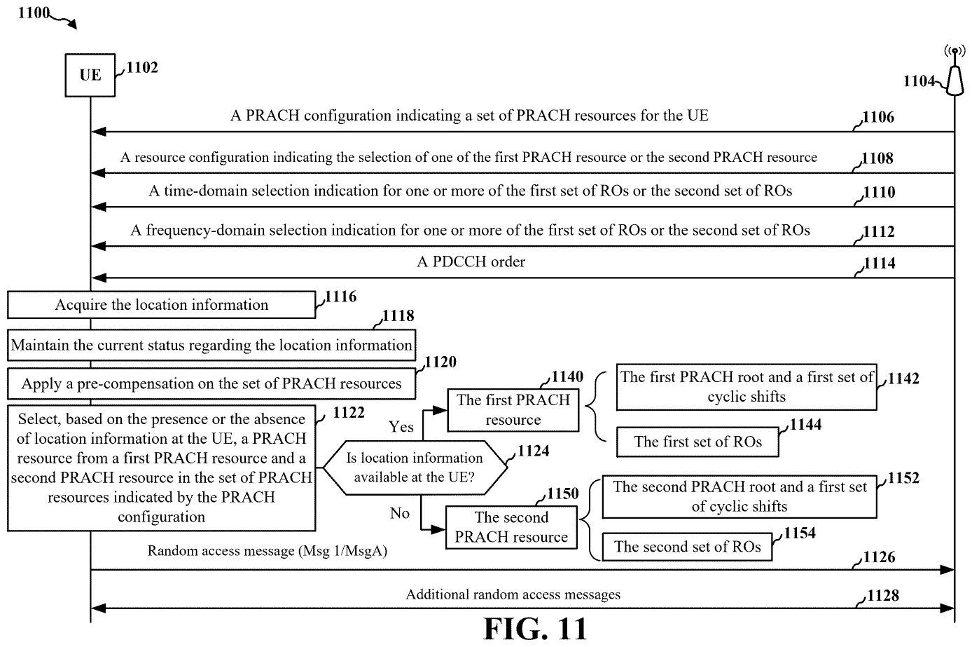

FIG. 11 is a call flow diagram 1100 illustrating a method of wireless communication in accordance with various aspects of this present disclosure. Various aspects are described in connection with a UE 1102 and a base station 1104. The aspects may be performed by the UE 1102 or the base station 1104 in aggregation and/or by one or more components of a base station 1104 (e.g., a CU 110, a DU 130, and/or an RU 140). The UE may be a GNSS UE (e.g., GNSS UE 1002) or a GNSS-less UE (e.g., GNSS-less UE 1006), and the base station 1104 may be associated with an NTN (e.g., satellite 1004).

As shown in FIG. 11, at 1106, a UE 1102 may receive from base station 1104 a PRACH configuration indicating a set of PRACH resources for the UE 1102. For example, referring to FIG. 10, a UE (e.g., GNSS UE 1002 or GNSS-less UE 1006) may receive from a base station (e.g., satellite 1004) a PRACH configuration. The PRACH configuration may indicate a set of PRACH resources that the UE may use for communication with the base station (e.g., satellite 1004). The UE may select different PRACH resources in the set of PRACH resources based on whether the UE possesses location information, such as information from the GNSS.

In some examples, at 1108, the base station 1104 may further transmit a resource configuration to the UE 1102. The resource configuration may indicate the selection of one of the first PRACH resource (e.g., at 1140) or the second PRACH resource (e.g., at 1150)

In some examples, at 1110, the UE 1102 may receive a time-domain selection indication for one or more of the first set of ROs or the second set of ROs. For example, referring to FIG. 10, the time-domain selection indication may indicate that GNSS UE (e.g., GNSS UE 1002) selects the set of ROs on even subframes (e.g., subframes 1020, 1022, 1024) and that GNSS-less UE (e.g., GNSS-less UE 1006) selects the set of ROs on odd subframes (e.g., subframes 1021, 1023, 1025).

In some examples, at 1112, the UE 1102 may receive a frequency-domain selection indication for one or more of the first set of ROs or the second set of ROs. For example, referring to FIG. 10, the frequency-domain selection may indicate that GNSS UE (e.g., GNSS UE 1002) selects the ROs at an ascending order at the frequency domain (e.g., starting from RO 1030) and that GNSS-less UE (e.g., GNSS-less UE 1006) selects the ROs at a descending order at the frequency domain (e.g., starting from RO 1032).

In some examples, the UE 1102 may be configured to access two different RACH resource pools. For example, the set of PRACH resources (at 1106) may include the first RACH resource pool and the second RACH resource pool. The first RACH resource pool may be designated for GNSS-less operations (e.g., the operations that do not involve the location information), and the second RACH resource pool may be designated for GNSS-based operations (e.g., the operations that involve the location information).

In some examples, at 1114, the UE 1102 may receive a PDCCH order from the base station 1104. In some examples, the PDCCH order may indicate which pool the UE 1102 may use for the PRACH transmission (e.g., at 1126). If the PDCCH order indicates the UE 1102 to use the GNSS pool (e.g., the second RACH resource pool), the UE 1102 may, at 1116, acquire the location information (e.g., GNSS information) before transmitting PRACH. On the other hand, if the PDCCH order indicates the UE 1102 to use the GNSS-less pool (e.g., the first RACH resource pool), the UE 1102 will not acquire GNSS information (e.g., GNSS signals) prior to the PRACH transmission. That is, the UE 1102 may, at 1118, maintain the current status regarding the location information.

In some examples, a GNSS-capable UE (e.g., GNSS UE) may receive a new PDCCH order (e.g., at 1114) that indicates the UE can transmit the PRACH without changing its GNSS state. Upon receiving this PDCCH order, the UE 1102 may derive the ROs using the SSB-to-RO mapping rules reserved for GNSS-less random access. In scenarios involving contention-based random access with the same PDCCH order, the UE 1102 may use a different cyclic shift and PRACH sequence partition reserved for GNSS-less random access, which may be configured according to the cell-specific RACH-ConfigGeneric.

In some aspects, at 1120, the UE 1102 may apply a UE-adjusted time-frequency pre-compensation to the PRACH resource. The amount of time-frequency pre-compensation may be obtained based on various factors. In some examples, the UE 1102 may obtain the pre-compensation based on the DCI carrying the PDCCH order (e.g., at 1114), and the DCI may include additional bits that indicate the timing and frequency pre-compensation. In some examples, the UE 1102 may obtain the pre-compensation based on the accumulated time and frequency adjustments. For example, the UE may use the accumulated time and frequency adjustments to derive the time-frequency pre-compensation. In some examples, the UE 1102 may obtain the time-frequency pre-compensation based on a cell-specific Timing Advance (TA) or Frequency Adjustment (FA) value, which may be indicated via a system information block (SIB). In some examples, the UE 1102 may obtain the time-frequency pre-compensation based on a dedicated TA or FA value, which may be indicated via RRC signaling.

In some aspects, the base station 1104 may transmit a PDCCH order (e.g., at 1114) with additional instructions about the GNSS state. In some examples, the additional instructions about the GNSS state may be based on the UE's indication of whether it can support GNSS or GNSS-less operations. In some examples, the additional instructions about the GNSS state may be based on the base station's tracking of the UE's most recent GNSS state (e.g., based on the UE's previous connection to the base station 1104).

At 1122, the UE 1102 may select, based on the presence or the absence of location information at the UE, a PRACH resource from a first PRACH resource 1140 and a second PRACH resource 1150 in the set of PRACH resources indicated by the PRACH configuration. In some examples, the UE may select the PRACH resources based on the time-domain selection indication received at 1110 or the frequency-domain selection indication received at 1112. In some examples, based on whether the location information is available at the UE (e.g., at 1124), the UE 1102 may select the first PRACH resource 1140 based on a first PRACH root and a first set of cyclic shifts (at 1142), or select the second PRACH resource 1150 based on a second PRACH root and a second set of cyclic shifts (at 1152). In some examples, the first PRACH resource 1140 may include a first set of ROs 1144, and the second PRACH resource 1150 may include a second set of ROs 1154, and the first set of ROs do not overlap with the second set of ROs in a time domain. For example, referring to FIG. 10, the first set of ROs 1144 may include the ROs on even subframes (e.g., subframes 1020, 1022, 1024), and the second set of ROs 1154 may include the ROs on odd subframes (e.g., subframes 1021, 1023, 1025). In some examples, the first set of ROs 1144 may not overlap with the second set of ROs 1154 in the frequency domain. For example, referring to FIG. 10, the first set of ROs 1144 may include RO 1030, and the second set of ROs 1154 may include RO 1032, which does not overlap with RO 1030 in the frequency domain.

At 1126, the UE 1102 may communicate with the base station 1104 using the selected PRACH resources. For example, the UE 1102 may transmit a random access message using the selected PRACH resources to the base station 1104 at 1126. The random access message may be, e.g., a Msg 1 transmission such as described in connection with FIG. 4A or a Msg A transmission, such as described in connection with FIG. 4B. The UE 1102 and the base station 1104 may exchange additional random access messages 1128, e.g., which may include any of the additional transmissions described in connection with FIG. 4A or FIG. 4B, for example.

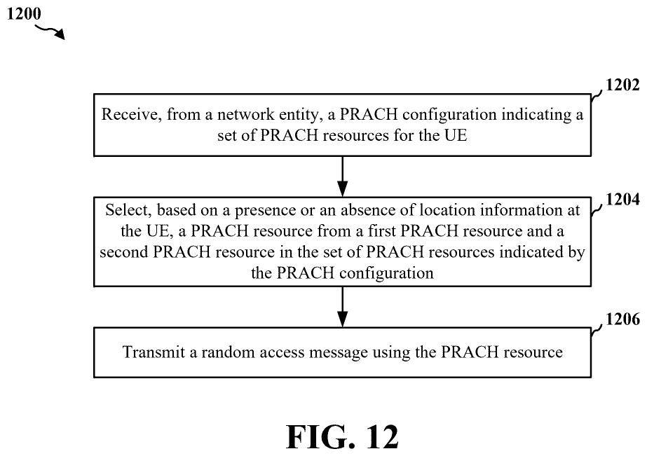

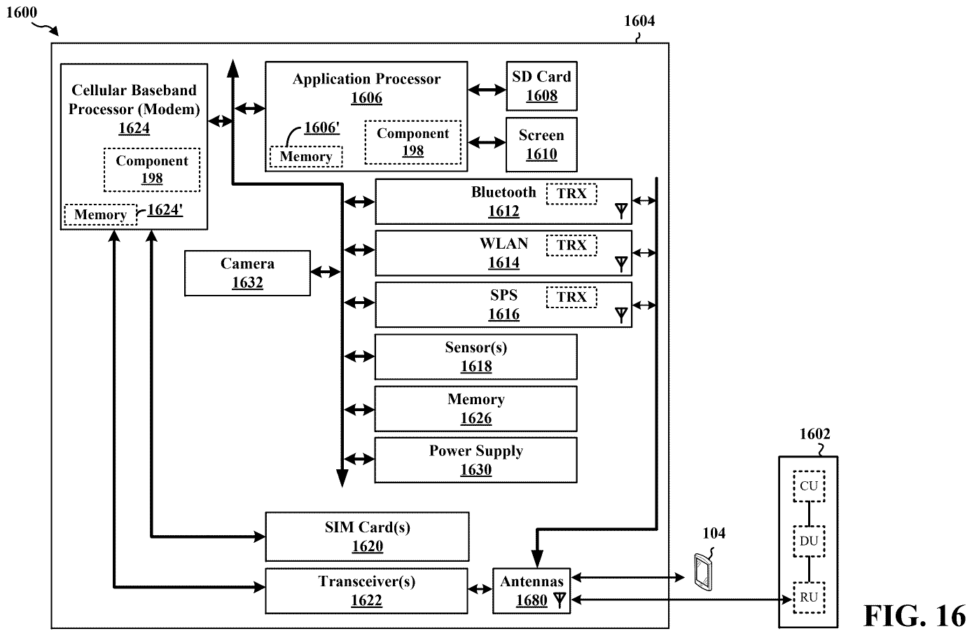

FIG. 12 is a flowchart 1200 illustrating methods of wireless communication at a UE in accordance with various aspects of the present disclosure. The method may be performed by a UE in coordination with a network entity. The network entity may be a base station, or a component of a base station, in the access network of FIG. 1 or a core network component (e.g., base station 102, 310, 1104; satellite 1004; or the network entity 1602 in the hardware implementation of FIG. 16). The UE may be the UE 104, 350, 1002, 1006, 1102, or the apparatus 1604 in the hardware implementation of FIG. 16. By enabling adaptive PRACH resource management in NTN for UEs with and without location information, such as that provided by the GNSS, the methods maintain connectivity for the UEs even under challenging conditions where GNSS signals are unavailable or unreliable, thereby enhancing the reliability of wireless communication. Additionally, by partitioning PRACH resources in the time domain or frequency domain for UEs with and without location information, the methods effectively minimize the overlap and potential conflict on resources for different types of UEs, thereby enhancing the overall resource efficiency for wireless communication.

As shown in FIG. 12, at 1202, the UE may receive a PRACH configuration from a network entity. The PRACH configuration may indicate a set of PRACH resources for the UE. FIG. 10 and FIG. 11 illustrate various aspects of the steps in connection with flowchart 1200. For example, referring to FIG. 11, the UE 1102 may, at 1106, receive a PRACH configuration from a network entity (e.g., base station 1104). The PRACH configuration may indicate a set of PRACH resources for the UE 1102. In some aspects, 1202 may be performed by the PRACH partition component 198.

At 1204, the UE may select a PRACH resource from a first PRACH resource and a second PRACH resource in the set of PRACH resources indicated by the PRACH configuration based on a presence or an absence of location information at the UE. For example, the UE may select the first PRACH resource in the set of PRACH resources based on the presence of the location information at the UE, or select the second PRACH resource in the set of PRACH resources based on the absence of the location information at the UE. For example, referring to FIG. 11, the UE 1102 may, at 1122, select a PRACH resource from a first PRACH resource 1140 and a second PRACH resource 1150 in the set of PRACH resources indicated by the PRACH configuration based on a presence or an absence of location information at the UE 1102. For example, the UE 1102 may select the first PRACH resource 1140 in the set of PRACH resources based on the presence of the location information at the UE 1102 (e.g., when the UE is GNSS UE 1002), or select the second PRACH resource 1150 in the set of PRACH resources based on the absence of the location information at the UE 1102 (e.g., when the UE is GNSS-less UE 1006). In some aspects, 1204 may be performed by the PRACH partition component 198.

At 1206, the UE may transmit a random access message using the PRACH resource. For example, referring to FIG. 11, the UE 1102 may, at 1126, transmit a random access message using the PRACH resource. Referring to FIG. 10, the UE (e.g., GNSS UE 1002 or GNSS-less UE 1006) may, at 1040 or 1050, transmit a random access message using the PRACH resource. In some aspects, 1206 may be performed by the PRACH partition component 198.

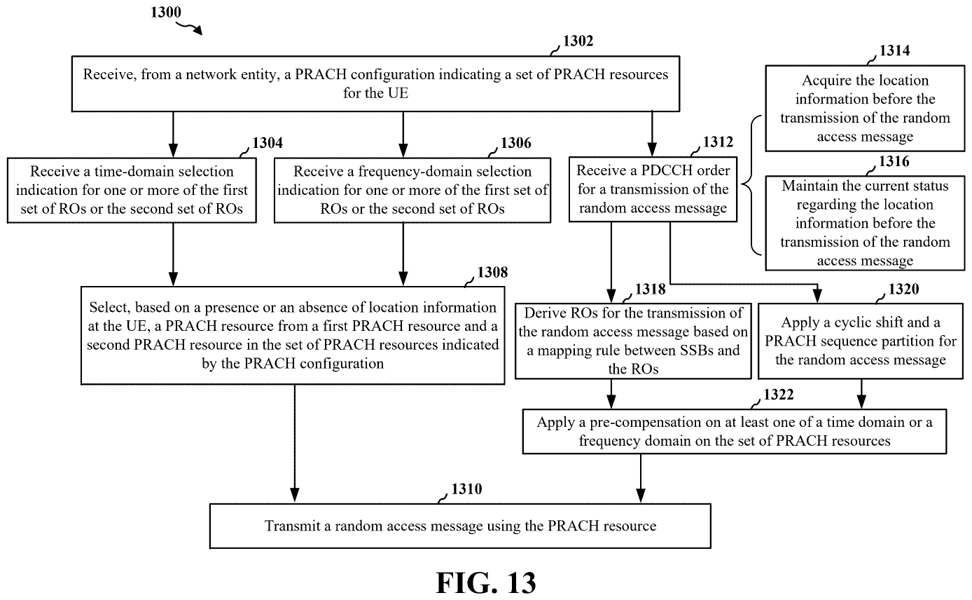

FIG. 13 is a flowchart 1300 illustrating methods of wireless communication at a UE in accordance with various aspects of the present disclosure. The method may be performed by a UE in coordination with a network entity. The network entity may be a base station, or a component of a base station, in the access network of FIG. 1 or a core network component (e.g., base station 102, 310, 1104; satellite 1004; or the network entity 1602 in the hardware implementation of FIG. 16). The UE may be the UE 104, 350, 1002, 1006, 1102, or the apparatus 1604 in the hardware implementation of FIG. 16. By enabling adaptive PRACH resource management in NTN for UEs with and without location information, such as that provided by the GNSS, the methods maintain connectivity for the UEs even under challenging conditions where GNSS signals are unavailable or unreliable, thereby enhancing the reliability of wireless communication. Additionally, by partitioning PRACH resources in the time domain or frequency domain for UEs with and without location information, the methods effectively minimize the overlap and potential conflict on resources for different types of UEs, thereby enhancing the overall resource efficiency for wireless communication.

As shown in FIG. 13, at 1302, the UE may receive a PRACH configuration from a network entity. The PRACH configuration may indicate a set of PRACH resources for the UE. FIG. 10 and FIG. 11 illustrate various aspects of the steps in connection with flowchart 1300. For example, referring to FIG. 11, the UE 1102 may, at 1106, receive a PRACH configuration from a network entity (e.g., base station 1104). The PRACH configuration may indicate a set of PRACH resources for the UE 1102. In some aspects, 1302 may be performed by the PRACH partition component 198.

At 1308, the UE may select a PRACH resource from a first PRACH resource and a second PRACH resource in the set of PRACH resources indicated by the PRACH configuration based on a presence or an absence of location information at the UE. For example, the UE may select the first PRACH resource in the set of PRACH resources based on the presence of the location information at the UE, or select the second PRACH resource in the set of PRACH resources based on the absence of the location information at the UE. For example, referring to FIG. 11, the UE 1102 may, at 1122, select a PRACH resource from a first PRACH resource 1140 and a second PRACH resource 1150 in the set of PRACH resources indicated by the PRACH configuration based on a presence or an absence of location information at the UE 1102. For example, the UE 1102 may select the first PRACH resource 1140 in the set of PRACH resources based on the presence of the location information at the UE 1102 (e.g., when the UE is GNSS UE 1002), or select the second PRACH resource 1150 in the set of PRACH resources based on the absence of the location information at the UE 1102 (e.g., when the UE is GNSS-less UE 1006). In some aspects, 1308 may be performed by the PRACH partition component 198.

At 1310, the UE may transmit a random access message using the PRACH resource. For example, referring to FIG. 11, the UE 1102 may, at 1126, transmit a random access message using the PRACH resource. Referring to FIG. 10, the UE (e.g., GNSS UE 1002 or GNSS-less UE 1006) may, at 1040 or 1050, transmit a random access message using the PRACH resource. In some aspects, 1310 may be performed by the PRACH partition component 198.

In some aspects, the location information may be based on the reception of a signal from a GNSS. For example, referring to FIG. 10, the location information may be based on the reception of a signal from a GNSS (e.g., from satellite 1004).

In some aspects, to select the first PRACH resource or the second PRACH resource in the set of PRACH resources indicated by the PRACH configuration (at 1308), the UE may select the first PRACH resource if the UE possesses the location information, or select the second PRACH resource if the UE does not possess the location information. For example, referring to FIG. 11, the UE 1102 may, at 1122, select the first PRACH resource 1140 if the UE 1102 possesses the location information, or select the second PRACH resource 1150 if the UE 1102 does not possess the location information.

In some aspects, the first PRACH resource may be selected based on a first PRACH root and a first set of cyclic shifts in an RO, and the second PRACH resource may be selected based on a second PRACH root and a second set of cyclic shifts in the RO. For example, referring to FIG. 11, the first PRACH resource 1140 may be selected based on a first PRACH root and a first set of cyclic shifts (e.g., at 1142) in an RO, and the second PRACH resource 1150 may be selected based on a second PRACH root and a second set of cyclic shifts (e.g., at 1152) in the RO.

In some aspects, a first cyclic shift interval in the first set of cyclic shifts may be shorter than a second cyclic shift interval in the second set of cyclic shifts. For example, referring to FIG. 11, a first cyclic shift interval (e.g., N_{CS}) in the first set of cyclic shifts (at 1142) may be shorter than a second cyclic shift interval (e.g., N_{CS}) in the second set of cyclic shifts (at 1152).

In some aspects, the first PRACH may correspond to a first restricted set in the set of PRACH resources, and the second PRACH resource may correspond to a second restricted set in the set of PRACH resources, and the second restricted set may be different from the first restricted set.

In some aspects, the first PRACH resource may include a first set of ROs, and the second PRACH resource may include a second set of ROs. The first set of ROs may not overlap with the second set of ROs in the time domain. For example, referring to FIG. 11, the first PRACH resource 1140 may include a first set of ROs 1144, and the second PRACH resource 1150 may include a second set of ROs 1154. The first set of ROs may not overlap with the second set of ROs in the time domain.

In some aspects, the first set of ROs may be in a first set of subframes in the set of PRACH resources, and the second set of ROs may be in a second set of subframes in the set of PRACH resources. The first set of subframes may be different from the second set of subframes. For example, referring to FIG. 10, the first set of ROs may be in a first set of subframes (e.g., subframes 1020, 1022, 1024) in the set of PRACH resources, and the second set of ROs may be in a second set of subframes (e.g., subframes 1021, 1023, 1025) in the set of PRACH resources. The first set of subframes (e.g., subframes 1020, 1022, 1024) may be different from the second set of subframes (e.g., subframes 1021, 1023, 1025).

In some aspects, the first set of subframes may include even subframes, and the second set of subframes may include odd subframes. For example, referring to FIG. 10, the first set of subframes (e.g., subframes 1020, 1022, 1024) may include even subframes, and the second set of subframes (e.g., subframes 1021, 1023, 1025) may include odd subframes.

In some aspects, at 1304, the UE may receive a time-domain selection indication for one or more of the first set of ROs or the second set of ROs from the network entity. For example, referring to FIG. 11, the UE 1102 may, at 1110, receive a time-domain selection indication for one or more of the first set of ROs (e.g., at 1144) or the second set of ROs (e.g., at 1154) from the network entity (base station 1104). In some aspects, 1304 may be performed by the PRACH partition component 198.

In some aspects, the first PRACH resource may include a first set of ROs, and the second PRACH resource may include a second set of ROs. The first set of ROs may not overlap with the second set of ROs in the frequency domain. For example, referring to FIG. 11, the first PRACH resource 1140 may include a first set of ROs 1144, and the second PRACH resource 1150 may include a second set of ROs 1154. Referring to FIG. 10, the first set of ROs (e.g., RO 1030) may not overlap with the second set of ROs (e.g., RO 1032) in the frequency domain.

In some aspects, the first set of ROs may be based on a first mapping rule between SSBs and the ROs, and the second set of ROs may be based on a second mapping rule between the SSBs and the ROs. For example, referring to FIG. 10, the first set of ROs (e.g., RO 1030) may be based on a first mapping rule between SSBs and the ROs (e.g., starting from the RO in the lowest available frequencies and moving upward), and the second set of ROs (e.g., RO 1032) may be based on a second mapping rule between the SSBs and the ROs (e.g., starting from the RO in the highest available frequencies and moving downward).

In some aspects, the first mapping rule may map the SSBs to the ROs based on an ascending order of the ROs, and the second mapping rule may map the SSBs to the ROs based on a descending order of the ROs. For example, referring to FIG. 10, the first mapping rule (e.g., starting from the RO in the lowest available frequencies and moving upward) may map the SSBs to the ROs based on an ascending order of the ROs, and the second mapping rule (e.g., starting from the RO in the highest available frequencies and moving downward) may map the SSBs to the ROs based on a descending order of the ROs.

In some aspects, at 1306, the UE may receive a frequency-domain selection indication for one or more of the first set of ROs or the second set of ROs from the network entity. For example, referring to FIG. 11, the UE 1102 may, at 1112, receive a frequency-domain selection indication for one or more of the first set of ROs or the second set of ROs from the network entity. In some aspects, 1306 may be performed by the PRACH partition component 198.

In some aspects, the frequency-domain selection indication may include the start index for one of the first set of ROs or the second set of ROs. For example, referring to FIG. 11, the frequency-domain selection indication (e.g., at 1112) may include the start index for one of the first set of ROs 1144 or the second set of ROs 1154.

In some aspects, the first PRACH resource may be for a first operation involving the location information, and the second PRACH resource may be for a second operation that does not involve the location information.

In some aspects, when the UE is capable of acquiring the location information, the UE may, at 1312, receive from the network entity a PDCCH order for a transmission of the random access message. In some examples, the PDCCH order indicates the UE to acquire the location information before the transmission of the random access message (at 1314). In some examples, the PDCCH order may indicate the UE to maintain the current status regarding the location information before the transmission of the random access message (at 1316). For example, referring to FIG. 11, the UE 1102 may, at 1114, receive from the network entity (base station 1104) a PDCCH order for the transmission of the random access message. In some examples, the PDCCH order indicates the UE 1102 to acquire the location information before the transmission of the random access message (at 1116). In some examples, the PDCCH order may indicate the UE 1102 to maintain the current status regarding the location information before the transmission of the random access message (at 1118). In some aspects, 1312, 1314, and 1316 may be performed by the PRACH partition component 198.

In some aspects, the PDCCH order may indicate the UE to maintain the current status regarding the location information before the transmission of the random access message (e.g., at 1316), and the UE may, at 1318, derive ROs for the transmission of the random access message based on a mapping rule between SSBs and the ROs. The mapping rule is applicable to the transmission of the random access message without involving the location information. In some aspects, 1318 may be performed by the PRACH partition component 198.

In some aspects, the PDCCH order may indicate the UE to maintain the current status regarding the location information before the transmission of the random access message (e.g., at 1316), and the UE may select the PRACH resource based on the current status regarding the location information. For example, if the current status does not involve the location information, the UE may, at 1320, apply a cyclic shift and a PRACH sequence partition for the random access message. The cyclic shift and the PRACH sequence partition may be applicable for the transmission of the random access message without involving the location information. In some aspects, 1320 may be performed by the PRACH partition component 198.

In some aspects, the transmission of the random access message may not involve the location information, and the UE may, at 1322, apply a pre-compensation on at least one of a time domain or a frequency domain on the set of PRACH resources. For example, referring to FIG. 11, the UE 1102 may, at 1120, apply a pre-compensation on at least one of a time domain or a frequency domain on the set of PRACH resources. In some aspects, 1322 may be performed by the PRACH partition component 198.

In some aspects, the pre-compensation may be based on one or more of: one or more bits in DCI carrying the PDCCH order, an accumulated adjustment in the time domain or the frequency domain, a TA or FA value indicated via an SIB, or a TA or FA value indicated via RRC signaling. For example, referring to FIG. 11, the pre-compensation (e.g., at 1120) may be based on one or more of: one or more bits in DCI carrying the PDCCH order (e.g., at 1114), an accumulated adjustment in the time domain or the frequency domain, a TA or FA value indicated via an SIB, or a TA or FA value indicated via RRC signaling from base station 1104.

In some aspects, the PDCCH order (e.g., at 1312) may further include an indication indicating a status regarding the location information, and the status may be based on one of: a support of the UE for one of the first operation involving the location information or the second operation that does not involve the location information, or a most recent status of the UE regarding the location information on a previous connection with the network entity. For example, referring to FIG. 11, the PDCCH order (e.g., at 1114) may further include an indication indicating a status regarding the location information, and the status may be based on one of: a support of the UE 1102 for one of the first operation involving the location information or the second operation that does not involve the location information, or a most recent status of the UE 1102 regarding the location information on a previous connection with the network entity (base station 1104).

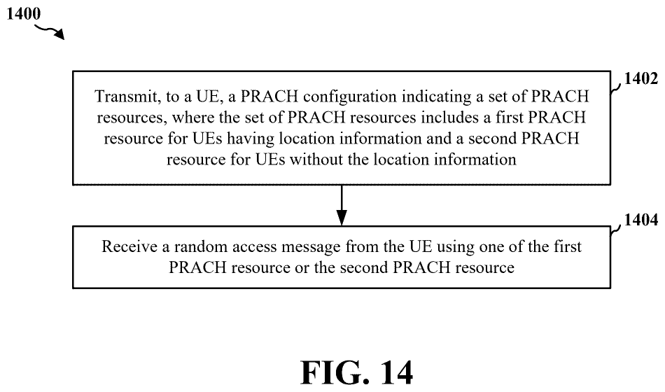

FIG. 14 is a flowchart 1400 illustrating methods of wireless communication at a network entity in accordance with various aspects of the present disclosure. The method may be performed by a network entity in coordination with a UE. The network entity may be a base station, or a component of a base station, in the access network of FIG. 1 or a core network component (e.g., base station 102, 310, 1104; satellite 1004; or the network entity 1602 in the hardware implementation of FIG. 16). The UE may be the UE 104, 350, 1002, 1006, 1102, or the apparatus 1604 in the hardware implementation of FIG. 16. By enabling adaptive PRACH resource management in NTN for UEs with and without location information, such as that provided by the GNSS, the methods maintain connectivity for the UEs even under challenging conditions where GNSS signals are unavailable or unreliable, thereby enhancing the reliability of wireless communication. Additionally, by partitioning PRACH resources in the time domain or frequency domain for UEs with and without location information, the methods effectively minimize the overlap and potential conflict on resources for different types of UEs, thereby enhancing the overall resource efficiency for wireless communication.

As shown in FIG. 14, at 1402, the network entity may transmit to a UE a PRACH configuration. The PRACH indication may indicate a set of PRACH resources. The set of PRACH resources may include a first PRACH resource for UEs having location information and a second PRACH resource for UEs without the location information. FIG. 10 and FIG. 11 illustrate various aspects of the steps in connection with flowchart 1400. For example, referring to FIG. 11, the network entity (base station 1104) may, at 1106, transmit to a UE a PRACH configuration. The PRACH indication may indicate a set of PRACH resources. The set of PRACH resources may include a first PRACH resource 1140 for UEs having location information and a second PRACH resource 1150 for UEs without the location information. In some aspects, 1402 may be performed by the PRACH partition component 199.

At 1404, the network entity may receive a random access message from the UE using one of the first PRACH resource or the second PRACH resource. For example, referring to FIG. 11, the network entity (base station 1104) may, at 1126, receive a random access message from the UE 1102 using one of the first PRACH resource 1140 or the second PRACH resource 1150. In some aspects, 1404 may be performed by the PRACH partition component 199.

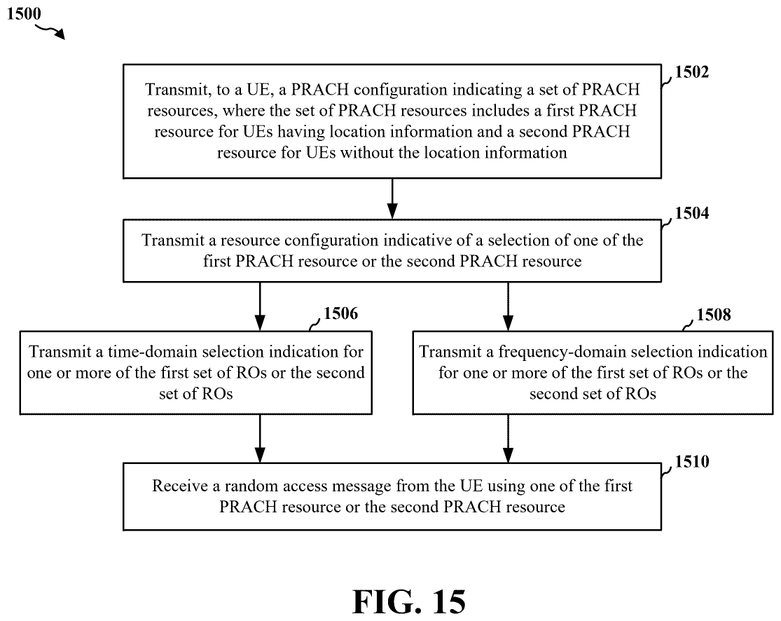

FIG. 15 is a flowchart 1500 illustrating methods of wireless communication at a network entity in accordance with various aspects of the present disclosure. The method may be performed by a network entity in coordination with a UE. The network entity may be a base station, or a component of a base station, in the access network of FIG. 1 or a core network component (e.g., base station 102, 310, 1104; satellite 1004; or the network entity 1602 in the hardware implementation of FIG. 16). The UE may be the UE 104, 350, 1002, 1006, 1102, or the apparatus 1604 in the hardware implementation of FIG. 16. By enabling adaptive PRACH resource management in NTN for UEs with and without location information, such as that provided by the GNSS, the methods maintain connectivity for the UEs even under challenging conditions where GNSS signals are unavailable or unreliable, thereby enhancing the reliability of wireless communication. Additionally, by partitioning PRACH resources in the time domain or frequency domain for UEs with and without location information, the methods effectively minimize the overlap and potential conflict on resources for different types of UEs, thereby enhancing the overall resource efficiency for wireless communication.

As shown in FIG. 15, at 1502, the network entity may transmit to a UE a PRACH configuration. The PRACH indication may indicate a set of PRACH resources. The set of PRACH resources may include a first PRACH resource for UEs having location information and a second PRACH resource for UEs without the location information. FIG. 10 and FIG. 11 illustrate various aspects of the steps in connection with flowchart 1500. For example, referring to FIG. 11, the network entity (base station 1104) may, at 1106, transmit to a UE a PRACH configuration. The PRACH indication may indicate a set of PRACH resources. The set of PRACH resources may include a first PRACH resource 1140 for UEs having location information and a second PRACH resource 1150 for UEs without the location information. In some aspects, 1502 may be performed by the PRACH partition component 199.

At 1510, the network entity may receive a random access message from the UE using one of the first PRACH resource or the second PRACH resource. For example, referring to FIG. 11, the network entity (base station 1104) may, at 1126, receive a random access message from the UE 1102 using one of the first PRACH resource 1140 or the second PRACH resource 1150. In some aspects, 1510 may be performed by the PRACH partition component 199.

In some aspects, the location information may be based on the reception of a signal from the GNSS. For example, referring to FIG. 10, the location information may be based on the reception of a signal from a GNSS (e.g., from satellite 1004).

In some aspects, the first PRACH resource is based on a first PRACH root and a first set of cyclic shifts in an RO, and the second PRACH resource is based on a second PRACH root and a second set of cyclic shifts in the RO. For example, referring to FIG. 11, the first PRACH resource 1140 may be based on a first PRACH root and a first set of cyclic shifts (e.g., at 1142) in an RO, and the second PRACH resource 1150 may be based on a second PRACH root and a second set of cyclic shifts (e.g., at 1152) in the RO.

In some aspects, at 1504, the network entity may transmit a resource configuration. The resource configuration may indicate the selection of one of the first PRACH resource or the second PRACH resource. For example, referring to FIG. 11, the network entity (base station 1104) may, at 1108, transmit a resource configuration. The resource configuration may indicate the selection of one of the first PRACH resource 1140 or the second PRACH resource 1150. In some aspects, 1504 may be performed by the PRACH partition component 199.

In some aspects, the first PRACH resource may include a first set of ROs, and the second PRACH resource may include a second set of ROs. The first set of ROs may not overlap with the second set of ROs in a time domain. For example, referring to FIG. 11, the first PRACH resource 1140 may include a first set of ROs 1144, and the second PRACH resource 1150 may include a second set of ROs 1154. The first set of ROs may not overlap with the second set of ROs in the time domain.

In some aspects, the first set of ROs may be in a first set of subframes in the set of PRACH resources, and the second set of ROs may be in a second set of subframes in the set of PRACH resources. The first set of subframes may be different from the second set of subframes. For example, referring to FIG. 10, the first set of ROs may be in a first set of subframes (e.g., subframes 1020, 1022, 1024) in the set of PRACH resources, and the second set of ROs may be in a second set of subframes (e.g., subframes 1021, 1023, 1025) in the set of PRACH resources. The first set of subframes (e.g., subframes 1020, 1022, 1024) may be different from the second set of subframes (e.g., subframes 1021, 1023, 1025).

In some aspects, the first set of subframes may include even subframes, and the second set of subframes may include odd subframes. For example, referring to FIG. 10, the first set of subframes (e.g., subframes 1020, 1022, 1024) may include even subframes, and the second set of subframes (e.g., subframes 1021, 1023, 1025) may include odd subframes.

In some aspects, at 1506, the network entity may transmit a time-domain selection indication for one or more of the first set of ROs or the second set of ROs. For example, referring to FIG. 11, the network entity (base station 1104) may, at 1110, transmit a time-domain selection indication for one or more of the first set of ROs 1144 or the second set of ROs 1154. In some aspects, 1506 may be performed by the PRACH partition component 199.

In some aspects, the first PRACH resource may include a first set of ROs, and the second PRACH resource may include a second set of ROs. The first set of ROs may not overlap with the second set of ROs in a frequency domain. For example, referring to FIG. 11, the first PRACH resource 1140 may include a first set of ROs 1144, and the second PRACH resource 1150 may include a second set of ROs 1154. Referring to FIG. 10, the first set of ROs (e.g., RO 1030) may not overlap with the second set of ROs (e.g., RO 1032) in the frequency domain.

In some aspects, the first set of ROs may be based on a first mapping rule between SSBs and the ROs, and the second set of ROs may be based on a second mapping rule between the SSBs and the ROs. For example, referring to FIG. 10, the first set of ROs (e.g., RO 1030) may be based on a first mapping rule between SSBs and the ROs (e.g., starting from the RO in the lowest available frequencies and moving upward), and the second set of ROs (e.g., RO 1032) may be based on a second mapping rule between the SSBs and the ROs (e.g., starting from the RO in the highest available frequencies and moving downward).

In some aspects, the first mapping rule may map the SSBs to the ROs based on an ascending order of the ROs, and the second mapping rule may map the SSBs to the ROs based on a descending order of the ROs. For example, referring to FIG. 10, the first mapping rule (e.g., starting from the RO in the lowest available frequencies and moving upward) may map the SSBs to the ROs based on an ascending order of the ROs, and the second mapping rule (e.g., starting from the RO in the highest available frequencies and moving downward) may map the SSBs to the ROs based on a descending order of the ROs.

In some aspects, at 1508, the network entity may transmit a frequency-domain selection indication for one or more of the first set of ROs or the second set of ROs. For example, referring to FIG. 11, the network entity (base station 1104) may, at 1112, transmit a frequency-domain selection indication for one or more of the first set of ROs 1144 or the second set of ROs 1154. In some aspects, 1508 may be performed by the PRACH partition component 199.

In some aspects, the frequency-domain selection indication may include the start index for one of the first set of ROs or the second set of ROs. For example, referring to FIG. 11, the frequency-domain selection indication (at 1112) may include the start index for one of the first set of ROs 1144 or the second set of ROs 1144.

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor (or processing circuitry) 1624 (also referred to as a modem) coupled to one or more transceivers 1622 (e.g., cellular RF transceiver). The cellular baseband processor(s) (or processing circuitry) 1624 may include at least one on-chip memory (or memory circuitry) 1624′. In some aspects, the apparatus 1604 may further include one or more subscriber identity modules (SIM) cards 1620 and at least one application processor (or processing circuitry) 1606 coupled to a secure digital (SD) card 1608 and a screen 1610. The application processor(s) (or processing circuitry) 1606 may include on-chip memory (or memory circuitry) 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) (or processing circuitry) 1624 communicates through the transceiver(s) 1622 via one or more antennas 1680 with the UE 104 and/or with an RU associated with a network entity 1602. The cellular baseband processor(s) (or processing circuitry) 1624 and the application processor(s) (or processing circuitry) 1606 may each include a computer-readable medium/memory (or memory circuitry) 1624′, 1606′, respectively. The additional memory modules 1626 may also be considered a computer-readable medium/memory (or memory circuitry). Each computer-readable medium/memory (or memory circuitry) 1624′, 1606′, 1626 may be non-transitory. The cellular baseband processor(s) (or processing circuitry) 1624 and the application processor(s) (or processing circuitry) 1606 are each responsible for general processing, including the execution of software stored on the computer-readable medium/memory (or memory circuitry). The software, when executed by the cellular baseband processor(s) (or processing circuitry) 1624/application processor(s) (or processing circuitry) 1606, causes the cellular baseband processor(s) (or processing circuitry) 1624/application processor(s) (or processing circuitry) 1606 to perform the various functions described supra. The cellular baseband processor(s) (or processing circuitry) 1624 and the application processor(s) (or processing circuitry) 1606 are configured to perform the various functions described supra based at least in part of the information stored in the memory (or memory circuitry). That is, the cellular baseband processor(s) (or processing circuitry) 1624 and the application processor(s) (or processing circuitry) 1606 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1624/application processor(s) (or processing circuitry) 1606 when executing software. The cellular baseband processor(s) (or processing circuitry) 1624/application processor(s) (or processing circuitry) 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) (or processing circuitry) 1624 and/or the application processor(s) (or processing circuitry) 1606, and in another configuration, the apparatus 1604 may be the entire UE (e.g., see UE 350 of FIG. 3) and include the additional modules of the apparatus 1604.

As discussed supra, the component 198 may be configured to receive a PRACH configuration from a network entity. The PRACH configuration may indicate a set of PRACH resources for the UE. The component 198 may be further configured to select a PRACH resource from a first PRACH resource and a second PRACH resource in the set of PRACH resources indicated by the PRACH configuration based on a presence or an absence of location information at the UE; and transmit a random access message using the PRACH resource. The component 198 may be further configured to perform any of the aspects described in connection with the flowcharts in FIG. 12 and FIG. 13, and/or performed by the UE 1102 in FIG. 11. The component 198 may be within the cellular baseband processor(s) (or processing circuitry) 1624, the application processor(s) (or processing circuitry) 1606, or both the cellular baseband processor(s) (or processing circuitry) 1624 and the application processor(s) (or processing circuitry) 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) (or processing circuitry) 1624 and/or the application processor(s) (or processing circuitry) 1606, includes means for receiving, from a network entity, a PRACH configuration indicating a set of PRACH resources for the UE; means for selecting, based on a presence or an absence of location information at the UE, a PRACH resource from a first PRACH resource and a second PRACH resource in the set of PRACH resources indicated by the PRACH configuration; and means for transmitting a random access message using the PRACH resource. The apparatus 1604 may further include means for performing any of the aspects described in connection with the flowcharts in FIG. 12 and FIG. 13, and/or aspects performed by the UE 1102 in FIG. 11. The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

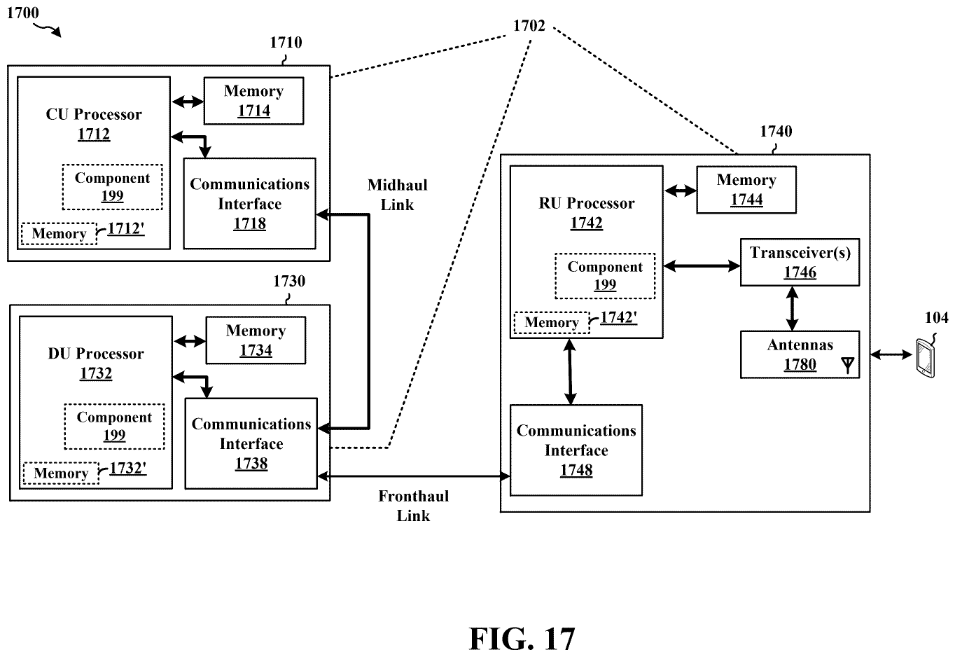

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include at least one CU processor (or processing circuitry) 1712. The CU processor(s) (or processing circuitry) 1712 may include on-chip memory (or memory circuitry) 1712′. In some aspects, the CU 1710 may further include additional memory modules 1714 and a communications interface 1718. The CU 1710 communicates with the DU 1730 through a midhaul link, such as an F1 interface. The DU 1730 may include at least one DU processor (or processing circuitry) 1732. The DU processor(s) (or processing circuitry) 1732 may include on-chip memory (or memory circuitry) 1732′. In some aspects, the DU 1730 may further include additional memory modules 1734 and a communications interface 1738. The DU 1730 communicates with the RU 1740 through a fronthaul link. The RU 1740 may include at least one RU processor (or processing circuitry) 1742. The RU processor(s) (or processing circuitry) 1742 may include on-chip memory (or memory circuitry) 1742′. In some aspects, the RU 1740 may further include additional memory modules 1744, one or more transceivers 1746, antennas 1780, and a communications interface 1748. The RU 1740 communicates with the UE 104. The on-chip memory (or memory circuitry) 1712′, 1732′, 1742′ and the additional memory modules 1714, 1734, 1744 may each be considered a computer-readable medium/memory (or memory circuitry). Each computer-readable medium/memory (or memory circuitry) may be non-transitory. Each of the processors (or processing circuitry) 1712, 1732, 1742 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit, to a UE, a PRACH configuration indicating a set of PRACH resources, where the set of PRACH resources includes a first PRACH resource for UEs having location information and a second PRACH resource for UEs without the location information; and receive a random access message from the UE using one of the first PRACH resource or the second PRACH resource. The component 199 may be further configured to perform any of the aspects described in connection with the flowcharts in FIG. 14 and FIG. 15, and/or performed by the base station 1104 in FIG. 11. The component 199 may be within one or more processors (or processing circuitry) of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1702 may include a variety of components configured for various functions. In one configuration, the network entity 1702 includes means for transmitting, to a UE, a PRACH configuration indicating a set of PRACH resources, where the set of PRACH resources includes a first PRACH resource for UEs having location information and a second PRACH resource for UEs without the location information; and means for receiving a random access message from the UE using one of the first PRACH resource or the second PRACH resource. The network entity 1702 may further include means for performing any of the aspects described in connection with the flowcharts in FIG. 14 and FIG. 15, and/or aspects performed by the base station 1104 in FIG. 11. The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity, a PRACH configuration indicating a set of PRACH resources for the UE; selecting, based on a presence or an absence of location information at the UE, a PRACH resource from a first PRACH resource and a second PRACH resource in the set of PRACH resources indicated by the PRACH configuration; and transmitting a random access message using the PRACH resource. By enabling adaptive PRACH resource management in NTN for UEs with and without location information, such as that provided by the GNSS, the methods maintain connectivity for the UEs even under challenging conditions where GNSS signals are unavailable or unreliable, thereby enhancing the reliability of wireless communication. Additionally, by partitioning PRACH resources in the time domain or frequency domain for UEs with and without location information, the methods effectively minimize the overlap and potential conflict on resources for different types of UEs, thereby enhancing the overall resource efficiency for wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes receiving, from a network entity, a physical random access channel (PRACH) configuration indicating a set of PRACH resources for the UE; selecting, based on a presence or an absence of location information at the UE, a PRACH resource from a first PRACH resource and a second PRACH resource in the set of PRACH resources indicated by the PRACH configuration; and transmitting a random access message using the PRACH resource.

Aspect 2 is the method of aspect 1, wherein the location information is based on receiving a signal from a global navigation satellite system (GNSS).

Aspect 3 is the method of any of aspects 1 to 2, wherein selecting the first PRACH resource or the second PRACH resource in the set of PRACH resources indicated by the PRACH configuration comprises: selecting, in response to the presence of the location information, the first PRACH resource, or selecting, in response to the absence of the location information, the second PRACH resource.

Aspect 4 is the method of any of aspects 1 to 3, wherein the first PRACH resource is selected based on a first PRACH root and a first set of cyclic shifts in a random access channel occasion (RO), and the second PRACH resource is selected based on a second PRACH root and a second set of cyclic shifts in the RO.

Aspect 5 is the method of aspect 4, where the method further includes deriving the second set of cyclic shifts by adding an offset to the first set of cyclic shifts.

Aspect 6 is the method of aspect 4, wherein a first cyclic shift interval in the first set of cyclic shifts is shorter than a second cyclic shift interval in the second set of cyclic shifts.

Aspect 7 is the method of aspect 4, wherein the first PRACH resource corresponds to a first restricted set in the set of PRACH resources, and the second PRACH resource corresponds to a second restricted set in the set of PRACH resources, wherein the second restricted set is different from the first restricted set.

Aspect 8 is the method of any of aspects 1 to 3, wherein the first PRACH resource includes a first set of random access channel occasions (ROs), and the second PRACH resource includes a second set of ROs, wherein the first set of ROs do not overlap with the second set of ROs in a time domain.

Aspect 9 is the method of aspect 8, wherein the first set of ROs is in a first set of subframes in the set of PRACH resources, and the second set of ROs is in a second set of subframes in the set of PRACH resources, wherein the first set of subframes is different from the second set of subframes.

Aspect 10 is the method of aspect 9, wherein the first set of subframes includes even subframes, and the second set of subframes includes odd subframes.

Aspect 11 is the method of aspect 8, where the method further includes: receiving, from the network entity, a time-domain selection indication for one or more of the first set of ROs or the second set of ROs.

Aspect 12 is the method of any of aspects 1 to 3, wherein the first PRACH resource includes a first set of random access channel occasions (ROs), and the second PRACH resource includes a second set of ROs, wherein the first set of ROs do not overlap with the second set of ROs in a frequency domain.

Aspect 13 is the method of aspect 12, wherein the first set of ROs is based on a first mapping rule between synchronization signal blocks (SSBs) and the ROs, and the second set of ROs is based on a second mapping rule between the SSBs and the ROs.

Aspect 14 is the method of aspect 13, wherein the first mapping rule maps the SSBs to the ROs based on an ascending order of the ROs, and the second mapping rule maps the SSBs to the ROs based on a descending order of the ROs.

Aspect 15 is the method of aspect 13, where the method further includes receiving, from the network entity, a frequency-domain selection indication for one or more of the first set of ROs or the second set of ROs.

Aspect 16 is the method of aspect 15, wherein the frequency-domain selection indication includes a start index for one of the first set of ROs or the second set of ROs.

Aspect 17 is the method of any of aspects 1 to 2, wherein the first PRACH resource is for a first operation involving the location information and the second PRACH resource is for a second operation that does not involve the location information.

Aspect 18 is the method of any of aspects 1 to 2, wherein the UE is capable of acquiring the location information, and where the method further includes receiving, from the network entity, a physical downlink control channel (PDCCH) order for a transmission of the random access message, wherein the PDCCH order indicates the UE to: acquire the location information before the transmission of the random access message, or maintain a current status regarding the location information before the transmission of the random access message.

Aspect 19 is the method of aspect 18, wherein the PDCCH order indicates the UE to maintain the current status regarding the location information before the transmission of the random access message, and wherein the method further includes deriving random access channel occasions (ROs) for the transmission of the random access message based on a mapping rule between synchronization signal Blocks (SSBs) and the ROs, wherein the mapping rule is applicable to the transmission of the random access message without involving the location information.

Aspect 20 is the method of aspect 18, wherein the PDCCH order indicates the UE to maintain the current status regarding the location information before the transmission of the random access message, and wherein selecting the PRACH resource includes selecting, based on the current status regarding the location information, the PRACH resource.

Aspect 21 is the method of aspect 18, wherein the transmission of the random access message does not involve the location information, and where the method further includes applying a pre-compensation on at least one of a time domain or a frequency domain on the set of PRACH resources.

Aspect 22 is the method of aspect 21, wherein the pre-compensation is based on one or more of: one or more bits in downlink control information (DCI) carrying the PDCCH order, an accumulated adjustment in the time domain or the frequency domain, a timing advance (TA) or frequency adjustment (FA) value indicated via a system information block (SIB), or the TA or FA value indicated via radio resource control (RRC) signaling.

Aspect 23 is the method of aspect 18, wherein the PDCCH order further includes an indication indicating a status regarding the location information, wherein the status is based on one of: a support of the UE for one of the first operation involving the location information or the second operation that does not involve the location information, or a most recent status of the UE regarding the location information on a previous connection with the network entity.

Aspect 24 is an apparatus for wireless communication at a UE, comprising: a processing system that includes processor circuitry and memory circuitry that stores code and is coupled with the processor circuitry, the processing system configured to cause the UE to perform the method of one or more of aspects 1-23.

Aspect 25 is an apparatus for wireless communication at a UE, comprising: at least one memory; and at least one processor coupled to the at least one memory and, where the at least one processor, individually or in any combination, is configured to perform the method of any of aspects 1-23.

Aspect 26 is the apparatus for wireless communication at a UE, comprising means for performing each step in the method of any of aspects 1-23.

Aspect 27 is an apparatus of any of aspects 24-26, further comprising a transceiver configured to receive or to transmit in association with the method of any of aspects 1-23.

Aspect 28 is a computer-readable medium (e.g., a non-transitory computer-readable medium) storing computer executable code at a UE, the code when executed by at least one processor causes the at least one processor to, individually or in any combination, perform the method of any of aspects 1-23.

Aspect 29 is a method of wireless communication at a network entity. The method includes transmitting, to a user equipment (UE), a physical random access channel (PRACH) configuration indicating a set of PRACH resources, wherein the set of PRACH resources includes a first PRACH resource for UEs having location information and a second PRACH resource for UEs without the location information; and receiving a random access message from the UE using one of the first PRACH resource or the second PRACH resource.

Aspect 30 is the method of aspect 29, wherein the location information is based on receiving a signal from a global navigation satellite system (GNSS).

Aspect 31 is the method of any of aspects 29 to 30, wherein the first PRACH resource is based on a first PRACH root and a first set of cyclic shifts in a random access channel occasion (RO), and the second PRACH resource is based on a second PRACH root and a second set of cyclic shifts in the RO.

Aspect 32 is the method of aspect 31, where the method further includes transmitting a resource configuration indicative of a selection of one of the first PRACH resource or the second PRACH resource.

Aspect 33 is the method of any of aspects 29 to 30, wherein the first PRACH resource includes a first set of random access channel occasions (ROs), and the second PRACH resource includes a second set of ROs, wherein the first set of ROs do not overlap with the second set of ROs in a time domain.

Aspect 34 is the method of aspect 33, wherein the first set of ROs is in a first set of subframes in the set of PRACH resources, and the second set of ROs is in a second set of subframes in the set of PRACH resources, wherein the first set of subframes is different from the second set of subframes.

Aspect 35 is the method of aspect 34, wherein the first set of subframes includes even subframes, and the second set of subframes includes odd subframes.

Aspect 36 is the method of any of aspects 33 to 34, where the method further includes transmitting a time-domain selection indication for one or more of the first set of ROs or the second set of ROs.

Aspect 37 is the method of aspect 30, wherein the first PRACH resource includes a first set of random access channel occasions (ROs), and the second PRACH resource includes a second set of ROs, wherein the first set of ROs do not overlap with the second set of ROs in a frequency domain.

Aspect 38 is the method of aspect 37, wherein the first set of ROs is based on a first mapping rule between synchronization signal blocks (SSBs) and the ROs, and the second set of ROs is based on a second mapping rule between the SSBs and the ROs.

Aspect 39 is the method of aspect 38, wherein the first mapping rule maps the SSBs to the ROs based on an ascending order of the ROs, and the second mapping rule maps the SSBs to the ROs based on a descending order of the ROs.

Aspect 40 is the method of aspect 38, where the method further includes transmitting a frequency-domain selection indication for one or more of the first set of ROs or the second set of ROs.

Aspect 41 is the method of aspect 40, wherein the frequency-domain selection indication includes a start index for one of the first set of ROs or the second set of ROs.

Aspect 42 is an apparatus for wireless communication at a network entity, comprising: a processing system that includes processor circuitry and memory circuitry that stores code and is coupled with the processor circuitry, the processing system configured to cause the network entity to perform the method of one or more of aspects 29-41.

Aspect 43 is an apparatus for wireless communication at a network entity, comprising: at least one memory; and at least one processor coupled to the at least one memory and, where the at least one processor, individually or in any combination, is configured to perform the method of any of aspects 29-41.

Aspect 44 is the apparatus for wireless communication at a network entity, comprising means for performing each step in the method of any of aspects 29-41.

Aspect 45 is an apparatus of any of aspects 42-44, further comprising a transceiver configured to receive or to transmit in association with the method of any of aspects 29-41.

Aspect 46 is a computer-readable medium (e.g., a non-transitory computer-readable medium) storing computer executable code at a network entity, the code when executed by at least one processor causes the at least one processor to, individually or in any combination, perform the method of any of aspects 29-41.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to cause the UE to:
receive, from a network entity, a physical random access channel (PRACH) configuration indicating a set of PRACH resources for the UE;
select, based on a presence or an absence of location information at the UE, a PRACH resource from a first PRACH resource and a second PRACH resource in the set of PRACH resources indicated by the PRACH configuration; and
transmit a random access message using the PRACH resource.

2. The apparatus of claim 1, further comprising a transceiver coupled to the at least one processor, wherein to receive the PRACH configuration indicating the set of PRACH resources for the UE, the at least one processor is configured to cause the UE to receive the PRACH configuration via the transceiver, and wherein the location information is based on receiving a signal from a global navigation satellite system (GNSS).

3. The apparatus of claim 2, wherein to select the first PRACH resource or the second PRACH resource in the set of PRACH resources indicated by the PRACH configuration, the at least one processor is configured to cause the UE to:
select, in response to the presence of the location information, the first PRACH resource, or
select, in response to the absence of the location information, the second PRACH resource.

4. The apparatus of claim 3, wherein the first PRACH resource is selected based on a first PRACH root and a first set of cyclic shifts in a random access channel occasion (RO), and the second PRACH resource is selected based on a second PRACH root and a second set of cyclic shifts in the RO.

5. The apparatus of claim 4, wherein the at least one processor is further configured to cause the UE to:
derive the second set of cyclic shifts by adding an offset to the first set of cyclic shifts.

6. The apparatus of claim 4, wherein a first cyclic shift interval in the first set of cyclic shifts is shorter than a second cyclic shift interval in the second set of cyclic shifts.

7. The apparatus of claim 4, wherein the first PRACH resource corresponds to a first restricted set in the set of PRACH resources, and the second PRACH resource corresponds to a second restricted set in the set of PRACH resources, wherein the second restricted set is different from the first restricted set.

8. The apparatus of claim 3, wherein the first PRACH resource includes a first set of random access channel occasions (ROs), and the second PRACH resource includes a second set of ROs, wherein the first set of ROs do not overlap with the second set of ROs in a time domain.

9. The apparatus of claim 8, wherein the first set of ROs is in a first set of subframes in the set of PRACH resources, and the second set of ROs is in a second set of subframes in the set of PRACH resources, wherein the first set of subframes is different from the second set of subframes.

10. The apparatus of claim 9, wherein the first set of subframes includes even subframes, and the second set of subframes includes odd subframes.

11. The apparatus of claim 8, wherein the at least one processor is further configured to cause the UE to:
receive, from the network entity, a time-domain selection indication for one or more of the first set of ROs or the second set of ROs.

12. The apparatus of claim 3, wherein the first PRACH resource includes a first set of random access channel occasions (ROs), and the second PRACH resource includes a second set of ROs, wherein the first set of ROs do not overlap with the second set of ROs in a frequency domain.

13. The apparatus of claim 12, wherein the first set of ROs is based on a first mapping rule between synchronization signal blocks (SSBs) and the ROs, and the second set of ROs is based on a second mapping rule between the SSBs and the ROs.

14. The apparatus of claim 13, wherein the first mapping rule maps the SSBs to the ROs based on an ascending order of the ROs, and the second mapping rule maps the SSBs to the ROs based on a descending order of the ROs.

15. The apparatus of claim 13, wherein the at least one processor is configured to cause the UE to:
receive, from the network entity, a frequency-domain selection indication for one or more of the first set of ROs or the second set of ROs.

16. The apparatus of claim 15, wherein the frequency-domain selection indication includes a start index for one of the first set of ROs or the second set of ROs.

17. The apparatus of claim 2, wherein the UE is capable of acquiring the location information, and wherein the at least one processor is configured to cause the UE to:
receive, from the network entity, a physical downlink control channel (PDCCH) order for a transmission of the random access message, wherein the PDCCH order indicates the UE to:
acquire the location information before the transmission of the random access message, or
maintain a current status regarding the location information before the transmission of the random access message.

18. The apparatus of claim 17, wherein the PDCCH order indicates for the UE to maintain the current status regarding the location information before the transmission of the random access message, and wherein the at least one processor is further configured to cause the UE to:
derive random access channel occasions (ROs) for the transmission of the random access message based on a mapping rule between synchronization signal Blocks (SSBs) and the ROs, wherein the mapping rule is applicable to the transmission of the random access message without involving the location information.

19. The apparatus of claim 17, wherein the PDCCH order indicates for the UE to maintain the current status regarding the location information before the transmission of the random access message, and wherein to select the PRACH resource, the at least one processor is configured to cause the UE to:
select, based on the current status regarding the location information, the PRACH resource.

20. The apparatus of claim 17, wherein the transmission of the random access message does not involve the location information, and wherein the at least one processor is further configured to cause the UE to:
apply a pre-compensation on at least one of a time domain or a frequency domain on the set of PRACH resources.

21. The apparatus of claim 20, wherein the pre-compensation is based on one or more of:
one or more bits in downlink control information (DCI) carrying the PDCCH order,
an accumulated adjustment in the time domain or the frequency domain,
a timing advance (TA) value or a frequency adjustment (FA) value indicated via a system information block (SIB), or
the TA value or the FA value indicated via radio resource control (RRC) signaling.

22. The apparatus of claim 17, wherein the PDCCH order further includes an indication indicating a status regarding the location information, wherein the status is based on one of:
a support of the UE for one of a first operation involving the location information or a second operation that does not involve the location information, or
a most recent status of the UE regarding the location information on a previous connection with the network entity.

23. An apparatus for wireless communication at a network entity, comprising:
at least one memory; and
at least one processor coupled to the at least one memory and, based at least in part on information stored in the at least one memory, the at least one processor is configured to cause the network entity to:
transmit, to a user equipment (UE), a physical random access channel (PRACH) configuration indicating a set of PRACH resources, wherein the set of PRACH resources includes a first PRACH resource for UEs having location information and a second PRACH resource for UEs without the location information; and
receive a random access message from the UE using one of the first PRACH resource or the second PRACH resource.

24. The apparatus of claim 23, wherein the location information is based on receiving a signal from a global navigation satellite system (GNSS).

25. The apparatus of claim 24, wherein the first PRACH resource is based on a first PRACH root and a first set of cyclic shifts in a random access channel occasion (RO), and the second PRACH resource is based on a second PRACH root and a second set of cyclic shifts in the RO.

26. The apparatus of claim 25, wherein the at least one processor is further configured to cause the network entity to:
transmit a resource configuration indicative of a selection of one of the first PRACH resource or the second PRACH resource.

27. The apparatus of claim 24, wherein the first PRACH resource includes a first set of random access channel occasions (ROs), and the second PRACH resource includes a second set of ROs, wherein the first set of ROs do not overlap with the second set of ROs in a time domain.

28. The apparatus of claim 27, wherein the first set of ROs is in a first set of subframes in the set of PRACH resources, and the second set of ROs is in a second set of subframes in the set of PRACH resources, wherein the first set of subframes is different from the second set of subframes.

29. A method of wireless communication at a user equipment (UE), comprising:
receiving, from a network entity, a physical random access channel (PRACH) configuration indicating a set of PRACH resources for the UE;
selecting, based on a presence or an absence of location information at the UE, a PRACH resource from a first PRACH resource and a second PRACH resource in the set of PRACH resources indicated by the PRACH configuration; and
transmitting a random access message using the PRACH resource.

30. A method of wireless communication at a network entity, comprising:
transmitting, to a user equipment (UE), a physical random access channel (PRACH) configuration indicating a set of PRACH resources, wherein the set of PRACH resources includes a first PRACH resource for UEs having location information and a second PRACH resource for UEs without the location information; and
receiving a random access message from the UE using one of the first PRACH resource or the second PRACH resource.
